(19) United States
(12) Patent Application Publication
(10) Pub. No.: US 2024/0152992 A1
(43) Pub. Date: May 9, 2024

(54) DATA INTELLIGENCE PLATFORM

(71) Applicant: Citizens Financial Group, Inc., Providence, RI (US)

(72) Inventors: Adam Boyd, Middletown, DE (US); Jeffrey Scott Lehman, Columbus, OH (US); Nathan McGregor, Dublin, OH (US); Steven Mark Bortnick, Willoughby Hills, OH (US); Lance Haugen, Hugo, MN (US)

(73) Assignee: Citizens Financial Group, Inc., Providence, RI (US)

(21) Appl. No.: 18/495,029

(22) Filed: Oct. 26, 2023

Related U.S. Application Data
(60) Provisional application No. 63/423,246, filed on Nov. 7, 2022.

(51) Int. Cl. G06Q 30/0601

(52) U.S. Cl. CPC G06Q 30/0631; G06Q 30/0643

(57) ABSTRACT

A system, method and computer-readable storage medium are disclosed herein. The system includes one or more servers, one or more processors and a memory storing computer-readable instructions that, when executed by the one or more processors, cause the system to perform operations. The operations include receiving data and information associated with a user, and executing a first ML algorithm to select which other ML algorithm to execute to determine a value profile associated with a collateral asset. Additional ML algorithms are executed to generate a collateral profile associated with the collateral asset, an activity profile associated with a user, and a household profile associated with the user. Data from among the profiles is combined to generate a digital asset, and advanced analytics are applied to the digital asset, in connection with rules and policies, to identify a user-specific product offering. The user-specific product offering is communicated to the user.

### CROSS-REFERENCE TO RELATED APPLICATION

This application claims the benefit of priority under 35 U.S.C. § 119(e) to prior U.S. Provisional Patent Application No. 63/423,246 filed Nov. 7, 2022, the contents of which is incorporated by reference herein to its entirety.

### TECHNICAL FIELD

The present disclosure generally relates to an electronic data intelligence platform that integrates disparate types of data from multiple independent data and information sources, integrates the same into a unique digital asset that is processable by downstream systems, and applies advanced analytics to the unique digital asset to pre-emptively determine, create, suggest and/or communicate user-specific digital product offerings.

### BACKGROUND

There currently does not exist a system or apparatus that is able to integrate and/or leverage multiple independent systems, computer software programs and/or data sources, and then intelligently model data and information obtained therefrom to identify and preemptively offer user-specific digital services and/or products based on predicted user behavior(s). This is due, in part, because existing systems and technology in the art are deficient on many levels. Such deficiencies include (without limitation): an inability automatically, pre-emptively (e.g., without user-input or initiation) and/or in real-time collect data from disparate data sources and repositories in a system-resource efficient manner; an inability to anticipate and/or predict user behavior, and in response, pre-emptively execute processing/modeling routines upstream, ahead of a user request or initiation; an inability to integrate disparate data types into a single, electronic bundle (e.g., data profile) that is by suitable for processing by other (downstream) systems; an inability to automatically and continually monitor and update modeling data, and to develop and maintain proprietary advanced analytics data; an absence of artificial intelligence (AI)/machine learning (ML) technology that correlates any number of unique data drivers (including those that may be user-agnostic); an inability to model and correlate multi-user data profiles; an inability to identify, develop and recommend user-specific digital service and product offerings based on proprietary advanced analytics; and others.

As a result of the foregoing (and other) deficiencies, existing systems in this art operate inefficiently, experience extensive latency, and/or operate using incomplete, inaccurate and/or outdated data.

Accordingly, there is a need for a new type of system, method and computer program product that addresses the foregoing and other deficiencies in the art.

### SUMMARY

A system according to the present disclosure may include a data intelligence platform. The data intelligence platform may comprise one or more servers, one or more processors and a memory storing computer-readable instructions that, when executed by the one or more processors, cause the data intelligence platform to perform operations. The operations may include receiving, from among one or more data sources, data and information associated with a user. The data and information may comprise activity data associated with one or more user accounts, household data associated with the user, and collateral data associated with a collateral asset. The operations may further include executing one or more machine learning (ML) modeling algorithms. A first ML modeling algorithm may be executed to select which ML modeling algorithm, from among a plurality of ML modeling algorithms, to execute to determine a value profile associated with the collateral asset. As input, the first ML modeling algorithm may receive the collateral data.

The operations may further include executing the selected ML modeling algorithm, using the collateral data as input, to generate a collateral profile associated with the collateral asset, executing a second ML modeling algorithm to generate an activity profile associated with the user, and executing a third ML modeling algorithm to generate a household profile associated with the user. The second ML modeling algorithm may the activity data as input, while the third ML modeling algorithm may receive the household data as input.

The operations may also include combining data from among the collateral profile, the activity profile and the household profile to create a digital asset that is in a format for processing by one or more downstream processing systems, and applying advanced analytics to the digital asset, in connection with one or more rules and policies, to identify a user-specific product offering for which the user is pre-approved. Once identified, the user-specific product offering may be communicated to a user device associated with the user via one or more communication channels.

A method according to the present disclosure may be executed, at least in part, by a data intelligence platform. The data intelligence platform may comprise one or more servers, one or more processors and a memory storing computer-readable instructions that, when executed by the one or more processors, cause the data intelligence platform to perform operations according to the method. The method may include receiving, from among one or more data sources, data and information associated with a user. The data and information may comprise activity data associated with one or more user accounts, household data associated with the user, and collateral data associated with a collateral asset. The method may further include executing one or more machine learning (ML) modeling algorithms. A first ML modeling algorithm may be executed to select which ML modeling algorithm, from among a plurality of ML modeling algorithms, to execute to determine a value profile associated with the collateral asset. As input, the first ML modeling algorithm may receive the collateral data.

The method may further include executing the selected ML modeling algorithm, using the collateral data as input, to generate a collateral profile associated with the collateral asset, executing a second ML modeling algorithm to generate an activity profile associated with the user, and executing a third ML modeling algorithm to generate a household profile associated with the user. The second ML modeling algorithm may the activity data as input, while the third ML modeling algorithm may receive the household data as input.

The method may also include combining data from among the collateral profile, the activity profile and the household profile to create a digital asset that is in a format for processing by one or more downstream processing systems, and applying advanced analytics to the digital asset, in connection with one or more rules and policies, to identify a user-specific product offering for which the user is pre-approved. Once identified, the user-specific product offering may be communicated to a user device associated with the user via one or more communication channels.

A computer-readable storage medium according to the present disclosure is disclosed herein. The computer-readable storage medium includes one or more sequences of computer-readable instructions that, when executed by one or more processors, cause a computer device or system to perform operations. The operations may include receiving, from among one or more data sources, data and information associated with a user. The data and information may comprise activity data associated with one or more user accounts, household data associated with the user, and collateral data associated with a collateral asset. The operations may further include executing one or more machine learning (ML) modeling algorithms. A first ML modeling algorithm may be executed to select which ML modeling algorithm, from among a plurality of ML modeling algorithms, to execute to determine a value profile associated with the collateral asset. As input, the first ML modeling algorithm may receive the collateral data.

The operations may further include executing the selected ML modeling algorithm, using the collateral data as input, to generate a collateral profile associated with the collateral asset, executing a second ML modeling algorithm to generate an activity profile associated with the user, and executing a third ML modeling algorithm to generate a household profile associated with the user. The second ML modeling algorithm may the activity data as input, while the third ML modeling algorithm may receive the household data as input.

The operations may also include combining data from among the collateral profile, the activity profile and the household profile to create a digital asset that is in a format for processing by one or more downstream processing systems, and applying advanced analytics to the digital asset, in connection with one or more rules and policies, to identify a user-specific product offering for which the user is pre-approved. Once identified, the user-specific product offering may be communicated to a user device associated with the user via one or more communication channels.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 illustrates an exemplary networked system comprising an exemplary data intelligence platform 110 according to the present disclosure.

FIG. 2 illustrates an exemplary system according to the present disclosure.

FIG. 3 illustrates an exemplary flow according to the present disclosure.

FIG. 4 illustrates an exemplary electronic document that has been automatically generated by a data intelligence platform according to the present disclosure.

FIG. 5 illustrates an exemplary system flow diagram according to the present disclosure.

FIG. 6 illustrates an exemplary method for generating and communicating a user-specific product offering according to the present disclosure.

FIGS. 7A-7K show a series of exemplary interactive GUI screens associated with a user experience (UX) for prompting or requesting a user-specific product offering according to the present disclosure.

FIGS. 8A-8C show a series of exemplary interactive GUI screens associated with a UX for accessing a user-specific product offering that has been generated preemptively, according to the present disclosure, without user prompting.

To facilitate understanding, identical reference numerals may have been used, where possible, to designate identical elements that are common to the figures. It is contemplated that elements disclosed in one embodiment may be beneficially utilized on other embodiments without specific recitation.

### DETAILED DESCRIPTION

The present disclosure generally relates to systems, methods and computer program products comprising a data intelligence platform. In some aspects, the data intelligence platform of the present disclosure may be configured to integrate multiple, independent systems, computer software programs and/or data sources; capture, store and/or model (e.g., via artificial intelligence (AI)/machine learning (ML) modeling components) multiple types of data obtained therefrom; generate user-specific data profiles based on the modeling; identify user-specific digital service and/or product offerings (having user-specific characteristics); and intelligently present the user-specific digital service and/or product offerings to users via any number or type of communication channels. Identifying the user-specific digital service and/or product offerings may include modeling a combination of historical, current (e.g., real-time) and/or predicted user activity data (of one or multiple users), user profile data associated with any number of users, data from one or more independent data sources, and any other data previously captured, generated and/or stored by the data intelligence platform. In addition, the user-specific digital service and/or product offerings may be determined so as to comply with any number of rules, policies, regulations, and/or any other pre-defined parameters (collectively, “rules and policies”). Notably, these (and other) aspects of the data intelligence platform may occur automatically, continually, in real-time and/or pre-emptively, including with no user interaction and/or initiation, and upstream of downstream service/product processing systems.

In some aspects, the data intelligence platform of the present disclosure may utilize machine learning models (including nested machine learning models) to model/analyze the various types of data it receives from various sources (and/or that it generates, including from the machine learning models), to develop advanced analytics, and to identify and/or create digital service and/or product offerings specifically for that user based on the advanced analytics. In some embodiments, the machine learning models (also referred to herein as machine learning modeling algorithms) may utilize and analyze data associated with multiple users, including affiliated users (e.g., co-requestors of an online digital product) and/or non-affiliated users (e.g., users with no affiliation, but that may share similar data profiles, activity profiles, or any other statistically-relevant data point(s)).

The present disclosure also relates to systems, methods and computer program products for generating an intuitive interactive graphic user interface (GUI) that intelligently, automatically, pre-emptively and/or in real-time provides users with access to the user-specific digital service and/or product offerings and enables users to provider additional user-specific data for downstream processing. As used herein, the term “user-specific product offerings” may refer to both user-specific product offerings and user-specific service offerings, and/or to any combination thereof.

Existing systems and technology in the art are deficient on many levels. Such deficiencies include (without limitation): an inability automatically, pre-emptively (e.g., without user-input or initiation) and/or in real-time collect data from disparate data sources and repositories in a system-resource efficient manner; an inability to anticipate and/or predict user behavior, and in response, pre-emptively execute processing/modeling routines upstream, ahead of a user request or initiation; an inability to integrate disparate data types into a single, electronic bundle (e.g., data profile) that is processable by downstream processing systems; an inability to automatically and continually monitor and update modeling data, and to develop and maintain proprietary advanced analytics data; an absence of artificial intelligence (AI)/machine learning (ML) technology that correlates any number of unique data drivers (including those that may be user-agnostic); an inability to model and correlate multi-user data profiles; an inability to identify, develop and recommend user-specific digital service and product offerings based on the platform's proprietary advanced analytics; and others.

As a result of the foregoing (and other) deficiencies, existing systems in this art operate inefficiently, experience extensive latency, and/or operate using incomplete, inaccurate and/or outdated data.

Having recognized the foregoing (and other) deficiencies, the Applicant has developed a new data intelligence platform with a new intuitive, interactive GUI that represents a significant technological advancement over any system or platform in existence. As will be discussed herein, features of this platform and GUI include (without limit) functions for replacing certain downstream processing functions with new, more efficient processing functions that define a novel data and analytics capability. This novel data and analytics capability is engineered to provide improved, highly precise results (e.g., zero or near-zero allowance (tolerance) from downstream processing rules and policies), while at the same time improving overall (system) operational efficiencies. In effect, the data and analytics capabilities of the data intelligence platform are transformed into an operational asset that digitally replaces existing processing decisions and outcomes. In addition, the new data and analytics capabilities (and their results) may be initiated automatically and upstream (e.g., ahead of user interaction or initiation), thereby making them accessible to users on demand and in real-time, while eliminating and/or reducing downstream processing requirements. In that regard, the data intelligence platform is able to predict and pre-emptively execute portions of the processing functions associated with certain digital product and/or service offering ahead of time. In addition, as a result of its artificial intelligence capacity, the data intelligence platform may be configured to limit its pre-emptive processing functions to those instances in which results of such pre-emptive processing are likely to meet or exceed certain criteria (e.g., pre-approval criteria, acceptance by user(s), etc.).

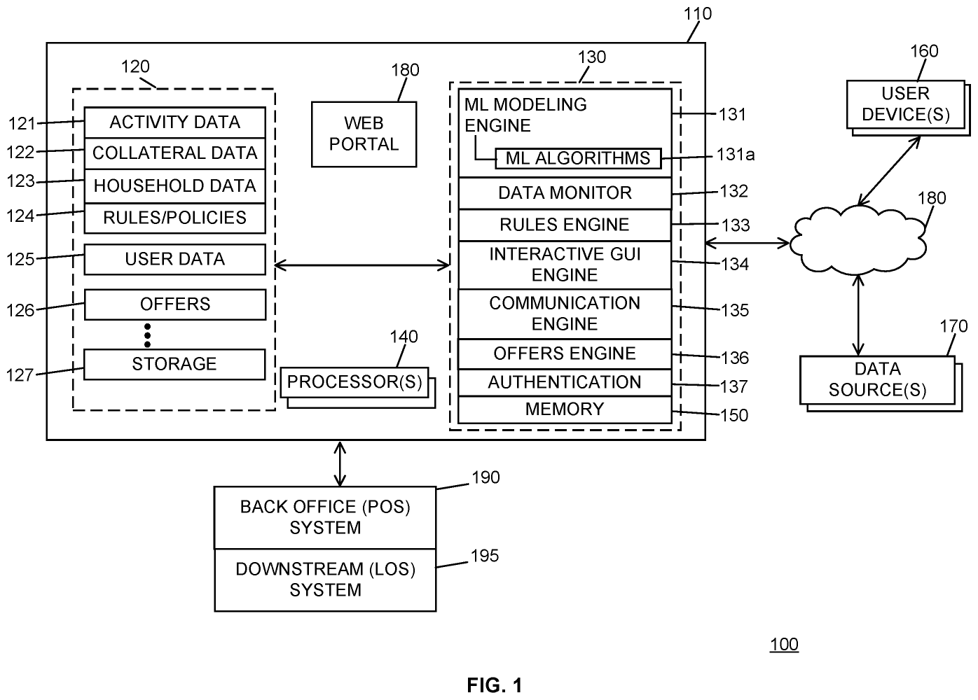

Turning now to FIG. 1, an exemplary networked system 100 comprising an exemplary data intelligence platform 110 according to the present disclosure is shown. For illustrative purposes, this exemplary system 100 (as well as other Figures within this disclosure) may be described in the context of an online, digital product offering, namely, an online home equity lending product. This exemplary digital product offering was selected for its ability to illustrate and demonstrate certain novel and unique aspects of the data intelligence platform 110 discussed herein. It should be noted, however, that the present disclosure is not so limited. To the contrary, the data intelligence platform 110 is specifically configured to improve data integration and processing, system efficiency, reduce latency, and provide other systematic improvements in connection with any industry, any type of data in any format, any type/number of data sources, any number of users, etc. Indeed, any industry or implementation which may be characterized by complex data having different data types dispersed across any number of disparate (independent) data sources, and in which generating accurate predictions, forecasts, simulations, analysis, etc. requires a holistic understanding of the relational connections and interdependencies between the different types of data, may benefit from the data intelligence platform 110 described herein. For example, the data intelligence platform 110 may be implemented to predict weather patterns based on historical weather data, industrial data (e.g., manufacturing emissions), and weather patterns in nearby geographic regions. Similarly, the data intelligence platform 110 may be implemented to predict vehicle life expectancies based on historical vehicle-specific data, regional population growth rates, and regulatory developments, just to name a few. As illustrated, the data intelligence platform 110 may be adapted for an industry and/or implementation.

Returning now to FIG. 1, the exemplary data intelligence platform 110 may itself be comprised of one or more servers, each comprising one or more processors 140 executing computer program logic (e.g., computer-readable instructions) stored in tangible non-transitory memory 150. As discussed herein, the computer program logic, when executed by the one or more processors 140, cause the data intelligence platform 110 to (among other operations) integrate and link multiple downstream systems 190, 195 (which may be a part of or independent from the data intelligence platform 110), user devices 160 and/or data sources 170, monitor and extract data and information therefrom, execute one or more ML algorithms 131a to preemptively develop user-specific product offerings, and provide authentication and efficient downstream processing for accepted user-specific product offerings. The one or more servers of the data intelligence platform 110 may be co-located or linked across one or more networks. Similarly, the various components of the data intelligence platform 110 may also be co-located (as depicted in FIG. 1), or they may be linked across one or more networks. As discussed further below, the computer-readable instructions executed by the one or more processors 140 may define one or more software modules, engines, routines, algorithms, code, etc., each for performing one or more operations described herein.

As shown, the data intelligence platform 110 may be communicatively coupled to one or more user devices 160 and one or more independent data sources 170 (e.g., third-party systems) via one or more communication networks 180. The communications network(s) 180 may include, for example, a private network (e.g., a local area network (LAN), a wide area network (WAN), intranet, etc.) and/or a public network (e.g., the Internet).

The one or more user devices 160 may include, without limit, any combination of mobile and/or stationary communication devices such as mobile phones, smart phones, tablets computers, laptop computers, desktop computers, server computers or any other computing device configured to capture, receive, store, render, display and/or disseminate data. The one or more user devices 160 may include a non-transitory memory, one or more processors executing computer-readable instructions, a communications interface which may be used to communicate with the data intelligence platform 110, a user input interface for inputting data and/or information to the one or more user devices 160 and/or a user display interface for presenting data and/or information on the one or more user devices 160. In some examples, the user input interface and the user display interface may be configured as an interactive graphical user interface (GUI). The one or more user devices 160 may also be configured to display an interactive GUI generated and/or rendered by the data intelligence platform 110.

In some embodiments, the one or more user devices 160 may include at least one software application. The software application may be representative of a web browser that provides access to a website or a stand-alone application. The one or more user devices 160 may invoke the software application to access one or more functionalities of data intelligence platform 110. For example, a user device 160 may be configured to execute the software application to access, reject and/or accept one or more alerts, notifications, suggestions, user-specific digital product offerings, etc. generated by the data intelligence platform 110, and/or to provide additional data and information responsive to the alerts, notifications, suggestions, user-specific digital product offerings, etc. Content that is displayed on the user device 160 may be transmitted from the data intelligence platform 110 to the user device 160, and subsequently processed by the software application for display via a graphical user interface (GUI). Data and information from the one or more user devices 160 may be obtained by the data intelligence platform 110 as a result of user input and/or other interactions with the user device(s) 160, transmitted automatically from the user device(s) 160 and/or extracted automatically from user device 160 memory.

The one or more independent data sources 170 may each comprise at least one computing device (e.g., a server computer, a desktop computer, a laptop computer, a smartphone, a tablet, etc.) executing computer-readable instructions to capture, receive, store and/or disseminate data and information. Such data and information may include historic and/or current (e.g., real-time) data and information specific to each of a plurality of users, such as each user's geolocation, electronic account(s) information, credit score data, purchase activity data, and the other types of user-specific data and information described herein, and/or data that may be relevant to, but not specific to, users (e.g., market data, interest rates, etc.). Examples of independent data sources 170 may include (without limit) point-of-sale (POS) systems, financial institution systems (e.g., a bank entity, a loan service, etc.), business entity systems (such as a utility company, a telecommunications company, etc.), government entity systems (e.g., federal agencies, state government agencies, etc.), credit agency systems, other users/systems, and/or any suitable source of data and/or information.

The data intelligence platform 110 may obtain data and/or information from among the one or more user devices 160 and the one or more independent data sources 170 via one or more input/output (I/O) interface(s) (not shown). The data intelligence platform 110 may also include one or more application program interfaces (APIs), now shown, for exchanging data and information among applications, devices and/or components within and external to the data intelligence platform 110. Data and information from the independent data sources 170 may be obtained through one or more live data feeds, one or more file transfers (including, in some examples, one or more secure file transfers), by data being pushed to data intelligence platform 110 and/or by the data intelligence platform 110 pulling and/or extracting the data and/or information from among the independent data sources 170.

The data intelligence platform 110 may include a data repository 120 comprising one or more storage devices (e.g., databases), accessible by the data intelligence platform 110, for storing historic and real-time data and information, machine learning modeling output, data generated by the data intelligence platform 110, etc. for any number and type of users. The one or more storage devices comprising the data repository 120 may be a part of the data intelligence platform 110, reside outside of the data intelligence platform 110, or a combination thereof.

The data and information stored in the data repository 120 may be received, retrieved, generated, monitored, and/or otherwise captured by the data intelligence platform 110. As shown, the data repository 120 may be configured to store, maintain and provide access to the different types and/or categories of data and information. In this example, the data and information may be characterized as user activity data 121, collateral data 122, household data 123, rules and policies data 124, user data 125, and offer data 126. It should be understood, however, that more, fewer and/or alternate types and categories of data and information may be stored in the data repository 120 according to the particular implementation. Further, the data repository 120 may include additional storage 127 for storing data and information that may not necessarily fall into one or more predetermined categories. The additional storage 127 may be a part of and/or accessible by the data intelligence platform 110. It should also be noted that the data and information may originate from any of the data intelligence platform 110, the user device(s) 160, the independent data source(s) 170, and/or any other source not shown in FIG. 1.

The activity data 121 may include data and information indicative of user activity, as it relates to user accounts. Such data and information may include, for example, account type, current and historical account balance, account credits and account debits, number of accounts, account open dates, payment history, overdraft status, account fees, profitability, collateral values, etc. Collectively, this type of data and information may provide user-specific account views. As discussed further below, this activity data 121 may be modeled to develop user activity profiles indicative of predicted user behaviors and/or account activities, for example.

The collateral data 122 may include data and information indicative of a value of users' collateral assets. For example, collateral data 122 may include geographic location/zip code, demographics data, area distribution data, competitor landscape data, pricing data, activity volume data, availability data, historical sales data, transaction history data, age/condition data, market value, collateral lien data, etc. associated with user-owned collateral assets and/or their geographic locations. In some embodiments, the data intelligence platform 110 may utilize the collateral data 122 (associated with one or more users) as modeling input to develop a collateral profile for any number of user-specific collateral assets. Each collateral profile(s) may comprise a value profile of one or more collateral assets that may, in turn, be used to determine characteristics of one or more user-specific digital product offerings (e.g., home value in connection with digital home equity lending product offering).

The household data 123 may include data and information indicative of users' wealth, net worth, credit-worthiness, and the like. For example, household data 123 may include user income, user age, user demographic profile, user behavior activity, asset data (type, quantity, value, etc.), credit history, credit utilization, property/collateral liens, property/collateral transactions, loan activity, loan-to-value ratios associated with loan activity, interest rates/terms of loan activity, remaining balance of loan activity, loan types, debt, payment history, etc. associated with any number of users In some embodiments, the data intelligence platform 110 may use portions of the household data 123 (pertaining to one or more users) as modeling input to develop a user-specific household profile reflective of each user's true wealth and qualifications for one or more user-specific digital product offerings.

The rules and policies data 124 may include any number of business, regulatory, compliance operational, pricing, product-specific, etc. rules and policies as generated, maintained and/or updated by the rules engine 133, discussed further below. As will also be discussed herein, the rules and policies data 124 may be utilized, in conjunction with other aspects of the data intelligence platform 110, to determine, suggest and pre-approve user-specific product offerings.

The user data 125 may comprise a combination of user personal identifiable information (PII), data categorized as activity data 121, collateral data 122 and/or household data 123, and/or any other type of user-related data and information.

The offers data 126 may include pre-approved user-specific product offerings (e.g., generated by the offer engine 136, discussed below), as well as associated offer details, offer status data and user data. For example, a user-specific product offering may comprise certain offer terms, offer expiration date, offer-specific authentication data (e.g., an offer code), data identifying a specific user pre-approved to accept, status data (e.g., accepted, rejected, etc.), and the like.

In some embodiments, data and information from across one or more of the foregoing categories may be monitored, received, retrieved (e.g., via data scrapes), generated and/or otherwise captured by the data intelligence platform 110 automatically, continually, periodically (e.g., according to a predetermined schedule) and/or on-demand. In this manner, the data intelligence platform 110 may have access to the most up-to-date data and information at any time. In some embodiments, certain data and information may be allocated to multiple categories and/or utilized for multiple ML algorithms 131a (discussed further below), according to the particular implementation. For example, collateral lien data may be allocated as both collateral data 122 and household data 123 for purposes of modeling such data to create a collateral data profile and a household data profile, as will be discussed further below.

The data intelligence platform 110 may also include an applications repository 130 that facilitates the performance of any of the operations, processes and/or functions described herein. In some embodiments, the applications repository 130 may include any number and type of software modules, engines, routines, algorithms, code, and the like, all or portions of which may be stored in the tangible non-transitory memory 150 shown in FIG. 1, or in one or more other tangible non-transitory memories (not shown). The software modules, engines, routines, algorithms, etc. described herein may comprise collections of code or computer-readable instructions stored on a media (e.g., memory 150 of platform 110) that represent a series of machine instructions (e.g., program code) that implements one or more steps, features and/or operations. Such machine instructions may be the actual computer code that the processor(s) 140 of the platform 110 interpret to implement the instructions or, alternatively, may be a higher level of coding of the instructions that is interpreted to obtain the actual computer code. The software modules, engines, routines, algorithms, etc. may also include one or more hardware components. One or more aspects of an example module, engine, routine, algorithm, etc. may be performed by the hardware components (e.g., circuitry) itself, rather as a result of the instructions.

As illustrated in FIG. 1, applications repository 130 may include, among others, a machine learning (ML) modeling engine 131 configured to generate, maintain and/or update one or more ML algorithms 131a (some of which may be nested ML algorithms), a data monitor 132, a rules engine 133, an interactive graphical user interface (GUI) engine 134, a communication engine 135, an offers engine 136, and an authentication engine 137, each of which comprises computer-readable instructions that, when executed by the one or more processors 140, enables each to generate, launch, execute and/or provide access to its respective modules, components, functions and/or operations. The applications repository 130 may be logically connected to the data repository 120, so as to enable the applications repository 130 to access and utilize data and information from the data repository 120 as needed; and conversely, to enable the data repository 120 to receive, store and update data and information received, retrieved, monitored, generated and/or otherwise captured by aspects of the applications repository 130. Components of the data intelligence platform 110 may communicate with each other via a data and control bus (not shown), and each such component may include a processor, a microcontroller, a circuit, and/or other hardware component(s) executing software (e.g., computer-readable instructions defining routines, processes, etc.) for performing its respective functions.

The ML modeling engine 131 may be configured to receive data and information from the data repository 120 and/or directly from among the data monitor 132, the user devices 160 and/or the independent data sources 170. This data and information may include historical, current (real-time) and/or predicted data (e.g., output from one or more ML algorithms 131a), and may include data and information associated with multiple users (e.g., users having similar profiles). The ML modeling engine 131 may then use this data and information to train, execute and/or update one or more ML algorithms 131a to achieve one or more objectives.

Output of the ML algorithms 131a may be used to generate, manage and/or dynamically update user-specific digital product offerings, electronic documents associated therewith, user profiles, data profiles, alerts, notifications, etc. In some embodiments, output of one or more ML algorithms 131a may be used as input to one or more other ML algorithms 131a; and in some embodiments, output from multiple ML algorithms 131a may be combined to create input for at least one other ML algorithm 131a. As further discussed below, one or more of the ML algorithms 131a may be configured to generate a model-generated selection as to which ML algorithm(s) 131a among a plurality of ML algorithms 131a the data intelligence platform 110 should execute to achieve a particular objective.

In some examples, execution of the ML algorithms 131a may be automatically executed or re-executed upon a detection of changes (e.g., by data monitor 132, discussed below) to any of the data and information that may impact prior modeling output, and the ML algorithms 131a may automatically be updated as a result of back-testing initiated by the data intelligence platform 110. In some embodiments, detecting changes to the data and information may include comparing current data and information (e.g., collected and/or monitored in real-time) to previously collected/monitored data and information, and evaluating the comparison against one or more predetermined threshold parameters. Comparisons that meet or exceed the one or more predetermined threshold parameters may then trigger re-execution of one or more of the ML algorithms 131a.

In some embodiments, the ML modeling engine 131 may be configured to execute or deploy multiple ML algorithms 131a at or near a same time, to enable the ML algorithms 131a to operate concurrently and cooperatively. For example, a first ML algorithm may be executed to select which particular ML algorithm, from among a plurality of available ML algorithms, to execute to generate a first data profile. Concurrent with execution of the first ML algorithm and/or the selected ML algorithm, the ML modeling engine 131 may execute one or more additional ML algorithms. Output generated by the selected ML algorithm and/or the one or more additional ML algorithms may then be combined to create input for yet another ML algorithm.

In some embodiments, the ML modeling engine 131 may train and execute the one or more ML algorithms 131a to achieve various and/or interrelated objectives (e.g., identify, generate, and/or update user-specific product offerings, predict likelihood of user being pre-approved, predict likelihood of pre-approved user accepting user-specific product offering, etc.). Depending on the particular objective, the ML modeling engine 131 may utilize any among various types and combinations of algorithms.

To train the one or more machine learning models, the machine learning modeling engine 122 may, for each machine learning model, collect, receive and/or extract historical and/or current (real-time) data and information from one or more data sources (e.g., data repository 120, user devices 160, independent data sources 170, data monitor 132, etc.). The data and information may also include data and information generated by one or more other ML algorithms 131a, as noted above.

In some embodiments, the data and information may be pre-processed (e.g., by a pre-processing device, not shown), which may include (among others) removing noise (e.g., duplicates, corrupted data, etc.), resolving missing data values, filtering, normalizing, scaling and augmenting the data (e.g., to add labels and additional data types), categorizing the data and information (e.g., activity data 121, collateral data 122, etc.) and the like. As a result of pre-processing, the data and information may be converted into a format that the ML algorithms 131a can understand and utilize effectively. In some embodiments, the ML modeling engine 131 may comprise a pre-processor and/or be configured to execute pre-processing operations, while in other embodiments, the data intelligence platform 110 may include a pre-processor device that is independent from (but in communication with) the ML modeling engine 131.

Once the data and information is pre-processed, the ML engine 131 may utilize the data and information to train a respective ML algorithm 131a. For example, activity data 121 may be used to train one or more ML algorithms 131a to generate an activity profile, the collateral data 122 may be used to train one or more ML algorithms 131a to generate a collateral profile, and so on.

In some embodiments, training a respective ML algorithm 131a may include splitting the pre-processed data and information into multiple data sets, each data set for use in training, validating and/or testing the respective ML algorithm 131a. For example, a first portion of the pre-processed data and information may be utilized to create a training data set that may then be fed into the respective ML algorithm 131a to identify patterns and relationships in the data and information by solving one or more objective functions, where each objective function may comprise one or more parameters. The patterns and relationships identified during training may include, for example, user tendencies, interdependencies between variables, user sentiment (e.g., to product offerings), user preferences, and the like.

A second portion of the pre-processed data and information may be utilized to create a validation data set, which may then be used to measure a performance of the respective ML algorithm 131a according to one or more performance metrics. That is, output generated by the respective ML algorithm 131a during training may be measured against the validation data set for accuracy (or any other performance metric). If the measured performance is unsatisfactory, one or more parameters of the objective function(s) may be adjusted and the performance re-measured. This process may be iterative and continue until the performance is deemed satisfactory (e.g., meets or exceeds the one or more performance metrics).

Following training, a third portion of the pre-processed data and information may be utilized to create a training data set to test the respective ML algorithm 131a. This may include, for example, applying the trained model to a simulated environment and/or data set, and measuring its effectiveness in one or more scenarios in view of the training data set.

The trained, validated and/or tested ML algorithms 131a may then be executed to achieve their respective and/or collective objectives. In this example, the objective may include developing holistic profile(s) of a user and the user's collateral, and applying advanced analytics to the determined profiles, in concert with any number of complex rules and policies (e.g., business, credit, pricing, compliance, regulatory, etc.) to identify, suggest and/or pre-approve the user for user-specific product offering(s). The user-specific product offering(s) may then be presented to the user (e.g. via an interactive GUI on the user's device 160), together with alerts, notifications, electronic documents, etc. In some embodiments, applying advanced analytics may comprise ML modeling (e.g., executing one or more ML algorithms 131a), pattern matching, forecasting, generating sentiment analysis, running simulations, data mining, and the like.

In some embodiments, execution of the ML algorithms 131a may be automatic and absent any user input. This may include for example, responsive to output generated by one or more ML algorithms 131a, results of advanced analytics meeting or exceeding one or more pre-determined thresholds, upon detecting changes in data and information collected by the data intelligence platform 110, upon detecting changes to one or more rules and policies (e.g., from the rules engine 133, discussed below), according to a predetermined schedule, upon an occurrence of one or more predetermined events (e.g., interest rates reaching a certain level, user account balance reaching a certain value, etc.), and so on. In some embodiments, execution of the ML algorithms 131a may be user-initiated, such as in response to user commands and/or input (e.g., via a user device 160) to the data intelligence platform 110.

Input to the ML algorithms 131a may include, without limit, real-time (current) and historic data and information from among the data repository 120, the user devices 160, the independent data sources 170, output from the ML algorithms 131a, and/or data and information generated or captured by one or more components of the applications repository 130. In some embodiments, the input may itself be pre-processed to remove noise (e.g., duplicates, corrupted data, etc.), resolve missing data values, filter, normalize, scale, and/or augment data included in the input (e.g., to add labels and additional data types), and the like, prior to executing the ML algorithms 131a.

In some embodiments, performance of the ML algorithms 131a may be evaluated over time. Then, depending on the performance evaluation, the ML modeling engine 131 may update and/or retrain one or more of the ML algorithms 131a. The performance of the ML algorithms 131a may comprise a measure of one or more performance metrics (e.g., accuracy, pre-approval rate, acceptance rate, etc.).

In some embodiments, the ML modeling engine 131 may be configured to train and execute ML algorithms 131a to identify, learn and generate one or more behavior patterns (e.g., tendencies) and/or preferences of a particular user, and then use the learned patterns and preferences as input to one or more other algorithms 131a to improve the acceptance rate, sentiment, and other aspects of user-specific product offerings generated for that particular user. Notably, the data and information used to identify and learn a user's behavior patterns and preferences may include historic, current and/or predicted data and information from among one or more other users (e.g., user profiles and/or behavior patterns of users sharing similar profile characteristic s).

The data monitor 132 may be configured to monitor data and information collected from among the user devices 160 and/or the independent data sources 170 to identify updates to the data and information and/or the presence of new data and information. The data monitor 132 may also be configured to monitor user activity and/or interactions with the data intelligence platform 110 itself (e.g., communications with platform-side users, messages sent to/received from user devices 160, clicked links, submitted electronic documents, etc.), and to monitor activity and operations of the data intelligence platform 110. In some embodiments, the data monitor 132 may be configured to perform filtering operations, to limit (e.g., based on one or more criteria) which data and information may be provided to one or more other components of the data intelligence platform 110, such as the ML modeling engine 131 (discussed above), for further processing. In some embodiments, the data monitor 132 may be configured to continuously and/or periodically monitor any of the data and information described herein.

The rules engine 133 may be configured generate, maintain and/or update rules and policies data 124 stored in the data repository 120. To do this, the rules engine 133 may itself collect data and information from among multiple sources, including independent data sources 170 such as government agency systems, regulatory agency systems, and the like, as well as pre-determined rules and policies stored by and/or coded into the data intelligence platform 110. In addition, the rules engine 133 may utilize modeling output from one or more ML algorithms 131a and analytics, for example, to inform an effectiveness, accuracy, relevance, impact, etc. of rules and policies, as well as to suggest rule and policy updates. The rules and policy updates may include, for example, modifying, removing and/or adding new rules and policies. In some embodiments, the rules engine 133 may be configured to generate the suggested updates to the rules and policies, and to implement one or more of the suggested updates to the rules and policies (e.g., automatically and/or responsive to operator authorization).

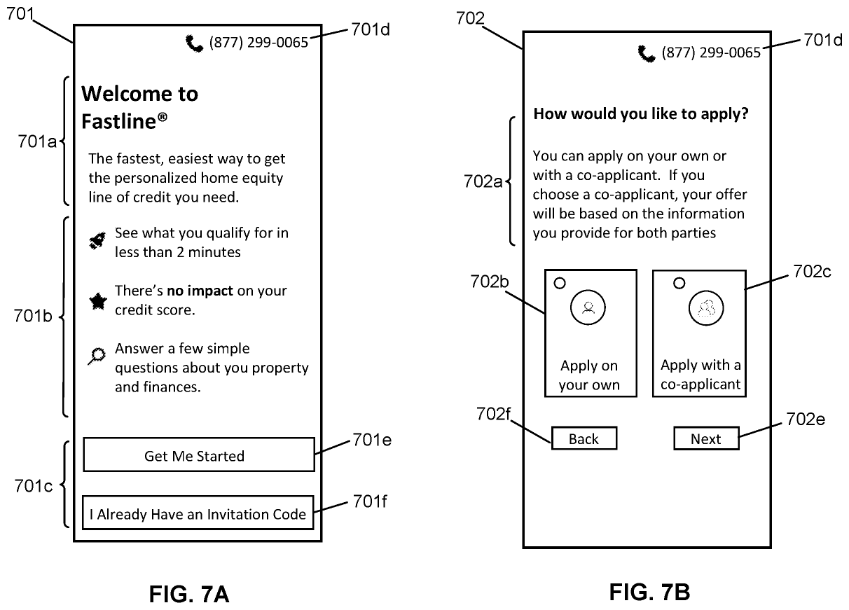

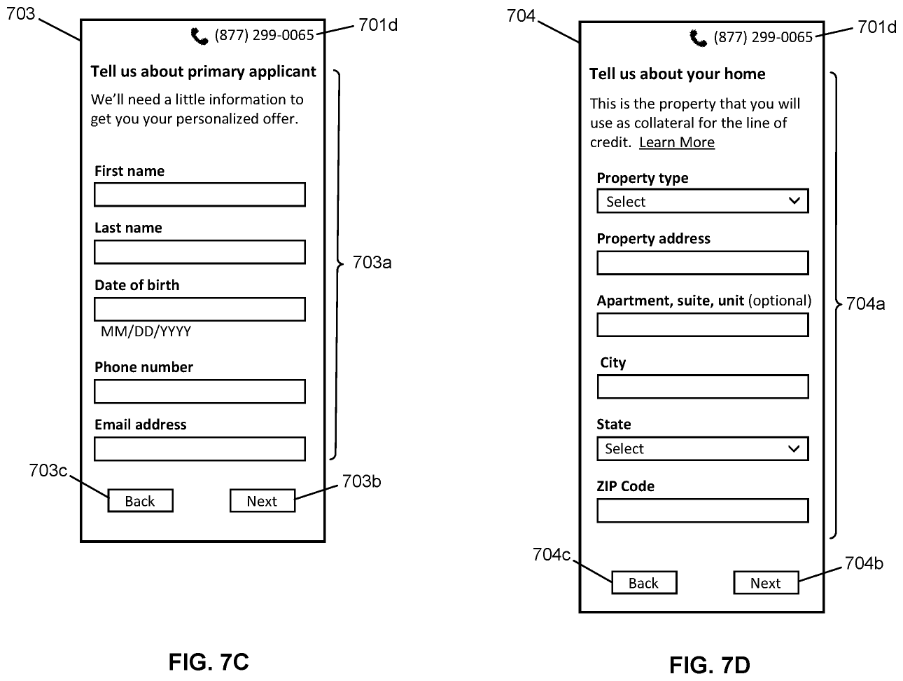

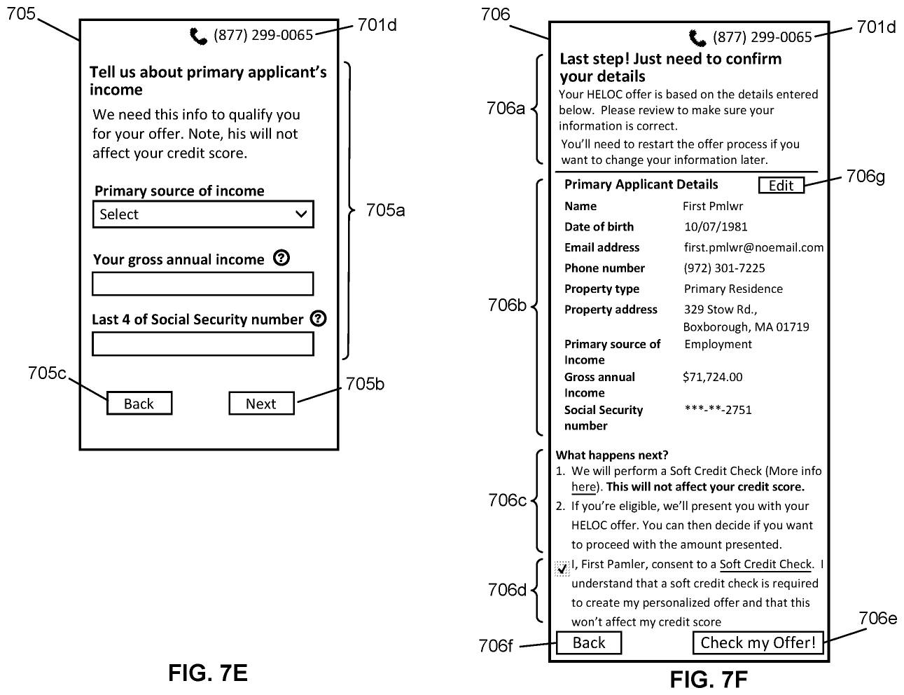

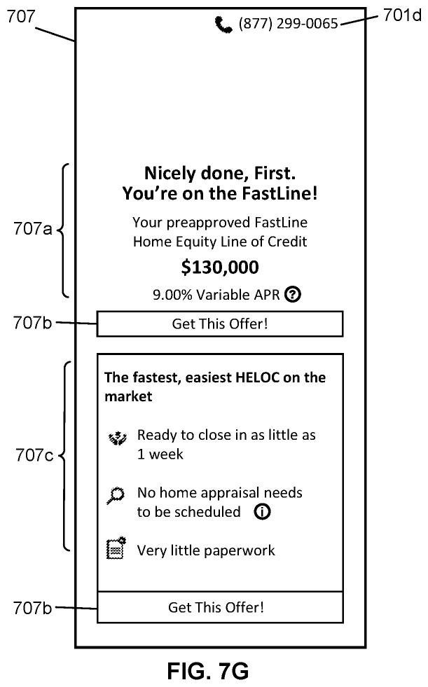

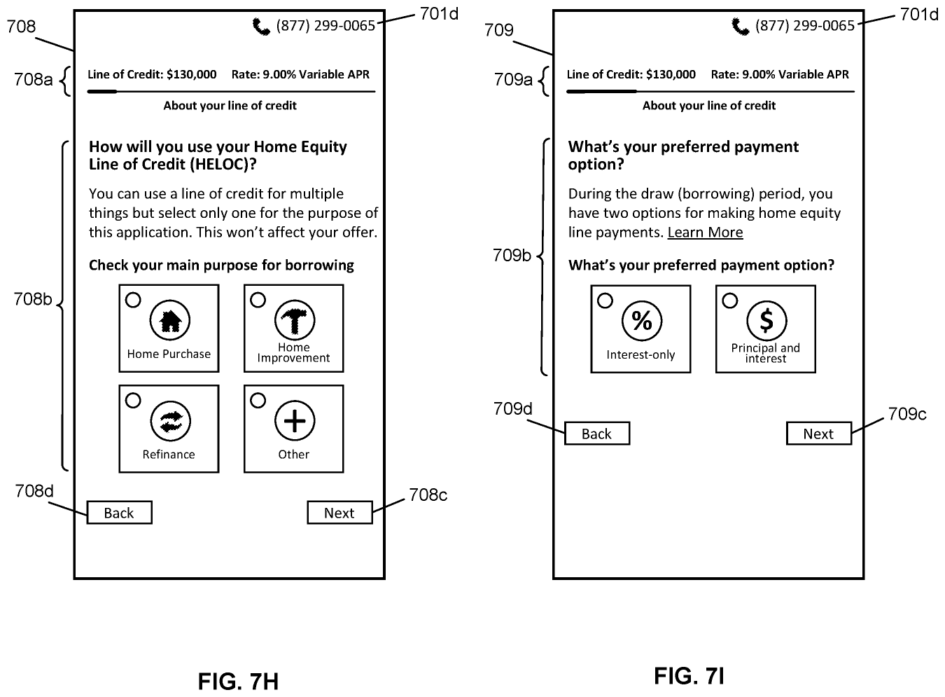

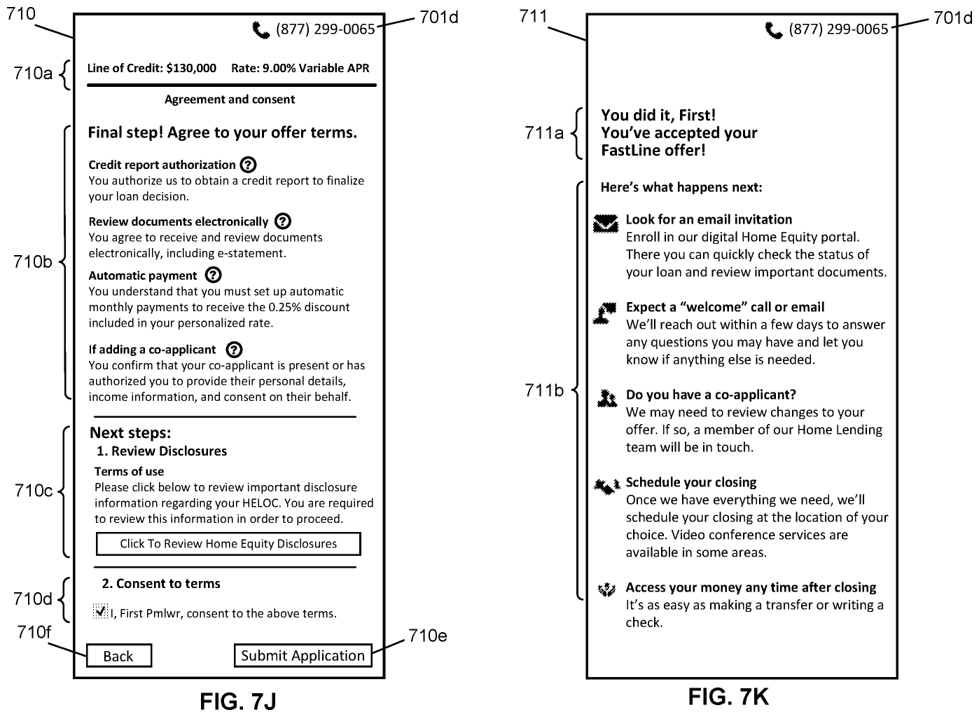

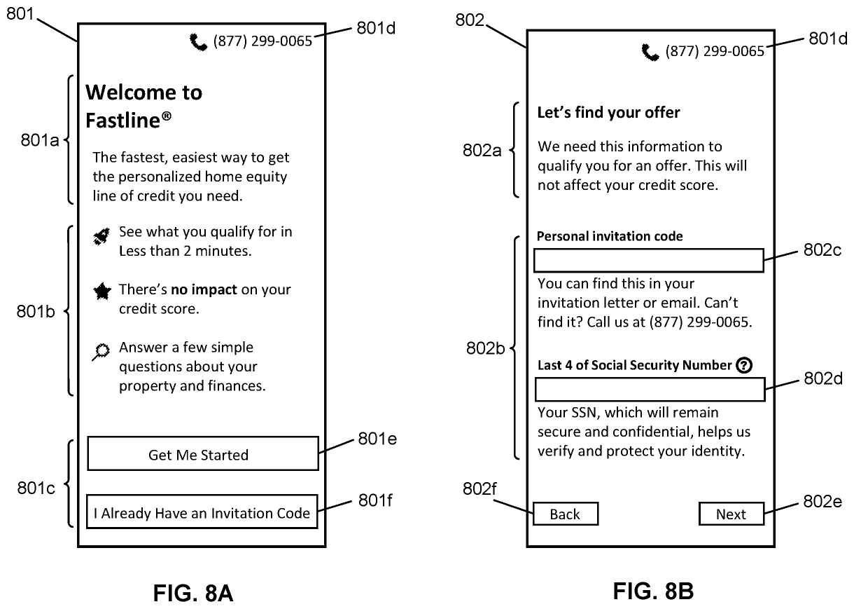

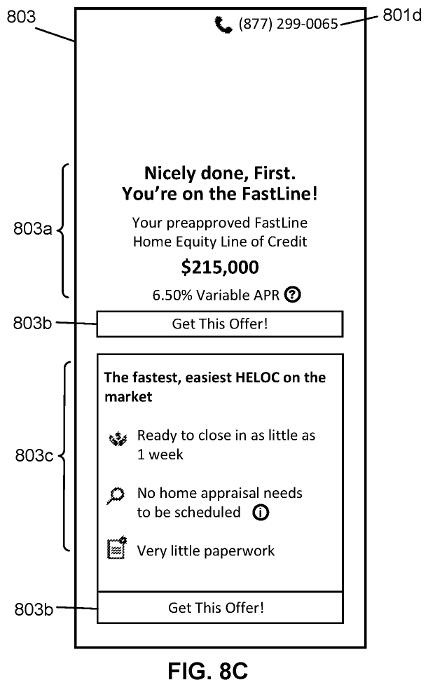

The interactive GUI engine 134 may be configured to generate one or more dynamic, interactive graphical interfaces (GUIs) for display on one or more devices (e.g., user device(s) 160). In some embodiments, the interactive GUI engine 134 may be configured to generate an interactive GUI having a uniquely configured arrangement of one or more user input regions (e.g., for inputting data, uploading documents, etc.), one or more notification (e.g., alert) indication(s) regions, one or more display regions, and one or more communication interaction regions. In some examples, one or more portions of interactive GUI may be automatically and dynamically updated (including in real-time or near real-time) responsive to new user-specific product offerings, changes to the user-specific product offerings, new or updated details associated with the user-specific product offerings, updates resulting from the execution and/or re-execution of one or more ML modeling algorithms 131a, and/or any other information and data that is new and/or updated (e.g., as determined by the ML modeling engine 131, based on monitored data, learned user tendencies/preferences, etc.). The interactive GUI may also be configured to permit and prompt user input, which in turn may automatically cause information being displayed on the interactive GUI to be updated in response to the user input. In some embodiments, interactive GUI engine 134 may transmit interactive GUIs to devices, such as user devices 160, for rendering and display thereon, and in some embodiments, interactive GUI engine 134 may render the interactive GUIs at the data intelligence platform 110, and transmit the rendered interactive GUIs to the user devices 160 for display thereon. Example screens of an exemplary interactive GUI are shown in FIGS. 7 and 8.

User input into an interactive GUI (e.g., via one or more user devices 160) may trigger one or more operations by the data intelligence platform 110. This may include, for example, initiating the ML modeling engine 122 to update details of a user-specific product offering based on a change in user data input via the interactive GUI. The interactive GUI may also display updates resulting from automated processing functions initiated without any user input whatsoever. This may include, for example, a change in a value profile of user's collateral asset (e.g., determined based on new information from one or more independent data sources 170) causing the data intelligence platform 110 to update terms of a user-specific product offerings (e.g., interest rate, amount of available equity for a HELOC loan product, etc.). The interactive GUI may further be configured to display one or more automated notification indications and/or reports (e.g., generated by the communication engine 135, discussed below) that may be shown via the user devices 160. In some examples, the automated notification indications may include one or more reports and/or profile summaries (e.g., activity profile summary, user income summary, etc.) generated by one or more of the ML algorithms 131a, as well as suggestions, forecasts, etc. that may be based on one or more of the profile determinations.

In some examples, the interactive GUI engine 126 may be configured to prepopulate one or more portions of an interactive GUI with information particular to a user, for example, based on the particular user's prior interactions with the data intelligence platform 110 and/or based on data stored or obtained by the data intelligence platform 110. In this manner, required user input may be reduced even further (e.g., 1-click acceptance of one or more user-specific product offerings). In other examples, one or more portions of the information may be manually entered (e.g., via a user device 104) or automatically updated from electronic accounts accessible by the data intelligence platform 110, in real or near real time.

The interactive GUI engine 134 may be configured to generate a presentation of various types and amounts of data and information aggregated from any number of sources, such as from the data intelligence platform 110, the independent data sources 170, etc., as well as various platform 110 operations accessible via a display screen of the user devices 160. For example, interactive GUI engine 134 may be configured to generate an interactive GUI that provides a simultaneous display of a user's account(s), live updates to user-specific product offerings and related terms/details thereof, live suggestions, live communication access, etc. In some embodiments, the data intelligence platform 110 may connect to one or more independent data sources 170 that house banking accounts, credit card accounts, credit bureau data, live market data, etc. (e.g., government entity systems, private entity systems, etc.) to generate presentations of such information on a user-specific interactive GUI display.

The communication engine 135 may be configured to generate and transmit user-specific communications (e.g., user-specific product offerings for which the user is pre-approved, updated user profile data, alerts, predictions, insights, suggestions, system-generated documentation, pre-populated electronic forms, etc.) automatically (e.g., based on output from the ML modeling engine 131, instructions from the data intelligence platform 110, at pre-programmed times, etc.) or responsive to user input (e.g., via an interactive GUI). These communications may, in turn, be displayed to users via the user devices 160. The communications engine 135 may also be configured to connect multiple users, and enable the users to share and display content and to communicate in any number of formats (text messaging, video, voice-call, etc.) via an interactive GUI displayed on a user's device 160. For example, upon receiving an alert or other communication indicative of a user-specific product offering, a user may initiate a live communication session with a platform-side user, share content with the platform-side user, provide information (e.g., enter data via an electronic document) and/or upload documents, all during the live communication session and all via the interactive GUI.

The offers engine 136 may be configured to generate, manage and update user-specific product offerings and/or its associated data. In some embodiments, the offers engine 136 may, in concert with other components of the data intelligence platform 110, combine components of modeling output pertaining to a particular user (e.g., from the ML modeling engine 131) to create a digital asset, and then apply advanced analytics to the digital asset (e.g., via one or more ML algorithms 131a), in concert with any number of complex rules and policies (e.g., from the rules engine) to generate one or more user-specific product offerings for that particular user. The offers engine 136 may further be configured to generate data associated with the user-specific product offering(s), such as offer details (e.g., terms, conditions, expiration, etc.), offer status data, offer authentication data, etc.

In some embodiments, the user-specific product offerings generated by the offers engine 136 may pertain to multiple (e.g., associated) users. For example, the data intelligence platform 110 may determine or recognize, based on a combination of data and information (e.g., activity data 121, collateral data 122, household data 123, user data 125, etc.), that user A is associated with user B (e.g., user A and user B may be co-owners of a collateral asset, they may be joint-owners of one or more accounts, etc.). In that case, a user-specific product offering generated for user A may include an option for user B to be a co-applicant/recipient of that user-specific product offering, and vice versa.

In some embodiments, data associated with the use-specific product offering(s) may include a listing of documents, authorizations, action items, etc. that the user may need to provide and/or undertake in order to accept and/or apply for each of the user-specific product offerings (e.g., each product offering may require its own respective combination of documents, authorizations, action items, etc.). In some embodiments, the listing of documents, authorizations, action items, etc. may be determined by one or more components of the data intelligence platform 110, and they may be presented (e.g., via the interactive GUI) to the user together with each of the user's respective user-specific product offerings. In this manner, the user is informed of all data, information, documents, action items, etc. that have to be provided or undertaken before commencing an acceptance and/or application process.

Collectively, the user-specific product offering and associated data may comprise offers data 126. The offers data 126 (which may include the digital asset), may then be stored in the data repository 120 (e.g., in an offers database) and/or transmitted to the particular user to which the user-specific product offering pertains (e.g., via the communication engine 135, discussed above). In some embodiments, user-specific product offerings and associated data may be submitted to the data repository 120 in batch, as a flat file. The offers engine 136 may further be configured to manage and update the offers data 126 responsive to changes in a status of product offerings (e.g., expired, accepted, etc.), changes to ML modeling output, and/or based on any other criteria.

The authentication engine 137 may be configured authenticate users and their respective user-specific product offerings. This may include, for example, receiving (e.g., from a user device 160) authentication data include user identifying information (e.g., portion of user's social security number) and a unique offer code (e.g., transmitted with a user-specific product offering), cross-referencing the authentication data with user data 125 and/or offer data 126 stored in the data repository 120, and confirming (or rejecting) that the user/product offering data match, and that the user-specific product offering remains available (e.g., it has not expired). If authenticity is confirmed, the user-specific product offering may proceed to downstream/back-office processing.

In operation, the data intelligence platform 110 may receive, retrieve, monitor, generate and/or otherwise capture data and information relating to one or more users and/or their respective collateral asset(s). Sources of the data and information may include user devices 160, independent data sources 170, other systems 190,195, the data intelligence platform 110 itself, and/or any other suitable source. As discussed above, the data and information may include activity data 121, collateral data 122, household data 123, and any other type of user data 125 (e.g., account data, PII, etc.), as well as data and information relating to rules and policies 124, platform-generated offers 126, and so on. In some embodiments, the collection and/or generating of data and information may be continuous, so as to avail the data intelligence platform 110 of the most current (e.g., real-time) data and information when performing any of the operations described herein, including executing the ML algorithms 131a, generating electronic documents, etc.

Having obtained the various types of data and information, the data intelligence platform 110 may then combine, integrate, correlate and/or model the data and information to determine holistic profile(s) of each user and each user's collateral asset(s). In some embodiments, this may include executing a first ML algorithm to determine which, from among other available modelling algorithms, may be best suited for modeling aspects of certain types of collected data 122. For example, in determining a value profile of a particular collateral asset associated with a particular user (e.g., a value of a residential home), the data intelligence platform 110 may execute a selection ML algorithm to determine, based on characteristics of the particular collateral asset (e.g., zip code, street address, square footage, etc.), which collateral valuation model (among multiple available collateral valuation models) may be best suited (e.g., most accurate) for generating a value profile for that particular collateral asset. Notably, similar to other ML algorithms 131a discussed herein, performance of the selection ML algorithm may be evaluated over time, and if needed, the data intelligence platform 110 may re-train the selection algorithm. The selection ML algorithm may also be back tested to confirm modeling accuracy and validity.

Continuing with the example, once the collateral valuation model is selected, it may be executed (using current and/or historic collateral data 122 as input) to generate a collateral profile for the particular collateral asset. This collateral profile may include a valuation profile of the collateral asset.

Next, the data intelligence platform 110 may execute a second ML algorithm, using current and/or historic activity data 121 as input, to generate an activity profile associated with the particular user. The activity profile may be indicative of predicted user behaviors and/or account activities. A third ML algorithm may then be executed to generate a household profile associated with the particular user, where the third ML algorithm utilizes current and/or historic household data 123 as input. The household profile may be indicative of the particular user's true wealth and qualifications for one or more user-specific digital product offerings.

The data intelligence platform 110 may then combine data from among the collateral profile, the activity profile and the household profile to create a digital asset that is in a format for further processing, either by one or more additional ML algorithms 131a and/or by one or more downstream processing systems 190, 195. In some embodiments, the downstream processing systems 190, 195 may include a back office point-of-sale (POS) system, a loan origination system (LOS), or any other back office/downstream processing system. As noted above, one or more of the downstream processing systems 190, 195 may be a part of and/or independent of the data intelligence platform 110.

Advanced analytics may then be applied to the digital asset, in connection with rules and policies data 124, to identify and/or suggest at least one user-specific product offering for which the particular user is pre-approved. That is, the digital asset (which includes a combination of collateral profile data, activity profile data and household profile data) together with rules and policy data 124 may be modeled (using one or more ML algorithm 131a) to identify products (and product characteristics) for which the particular user is likely to qualify and/or likely to accept, and/or that comply with any number of rules and policies 124, and to select from among the identified products one or more products to offer to the particular user. The selected products may be referred to as user-specific product offering(s) and stored (tougher with offer-related data) as offers data 126 in the data repository 120. For purposes of this example, the user-specific product offering may comprise a home equity lending product having a particular set of characteristics (credit line or credit limit, interest rate, etc.).

The data intelligence platform 110 may then communicate (e.g., via the communication engine 135) the user-specific product offering to the particular user via one or more communication channels (e.g., e-mail, text message, etc. to a user device 160). In addition, the data intelligence platform 110 may automatically initiate and generate electronic documentation that may be needed to satisfy certain downstream processing requirements (e.g., under-writing rules and policies and operational or regulatory documentation compliance), discussed further below.

In some embodiments, the data intelligence platform 110 may further be configured to monitor (e.g., via the data monitor 132) at least one among the user devices 160, the data sources 170, other systems 190,195, components of the data intelligence platform 110 itself (e.g., ML modeling engine 131), additional storage 127 and/or any other data source for changes to any of the data and information previously collected and/or generated, or indications that the data and information should be updated. The monitoring may occur continuously, periodically (e.g., according to a predetermined schedule) and/or on-demand. Upon detecting any such changes, data intelligence platform 110 may cause the ML modeling engine 131 to automatically re-execute one or more ML modeling algorithms 131a. For example, upon detecting a change to any of the activity data 121, the collateral data 122, the household data 123, the rules and policies data 124, and/or any other data and information that may impact prior modeling output (including the suggested user-specific product offering), one or more of the ML modeling algorithms 131a may be re-executed to update any of the collateral profile, the activity profile and the household profile. The digital asset may also be updated (or re-created) to reflect any updates to any of the profiles, and advanced analytics may be applied (or re-applied) to the updated digital asset, in connection with the rules and policies data 124, to identify and/or suggest at least one updated user-specific product offering for which the particular user is pre-approved. In another example, modeling output from one or more ML algorithms 131a may indicate that the array of data and information used to create the digital asset may be improved (e.g., to include data that is more reliable or more informative), in which case creation of the digital asset may be updated to combine a different array of data and information from among the collateral profile, the activity profile and/or the household profile. In some embodiments, updates to the rules and policies data 124 may result in automatically re-applying the advanced analytics to the digital asset (and/or updated digital asset).

In some embodiments, the data intelligence platform 110, via the interactive GUI engine 134, may be configured to generate and transmit an interactive graphic user interface (GUI) to the user device 160 for rendering and display thereon, and in some embodiments, the data intelligence platform 110 may render the interactive GUI and transmit the rendered interactive GUI to the user device 160 for display thereon. The interactive GUI may then be utilized to view and display the user-specific product offering via the user device 160. In some embodiments, data intelligence platform 110 may be further configured to dynamically update the interactive GUI to display any updates or changes as they occur. This may include, for example, updates or changes resulting from re-execution of any of the ML modeling algorithms 131a, re-application of advanced analytics, etc., which may include re-identifying and/or updating the user-specific product offering.

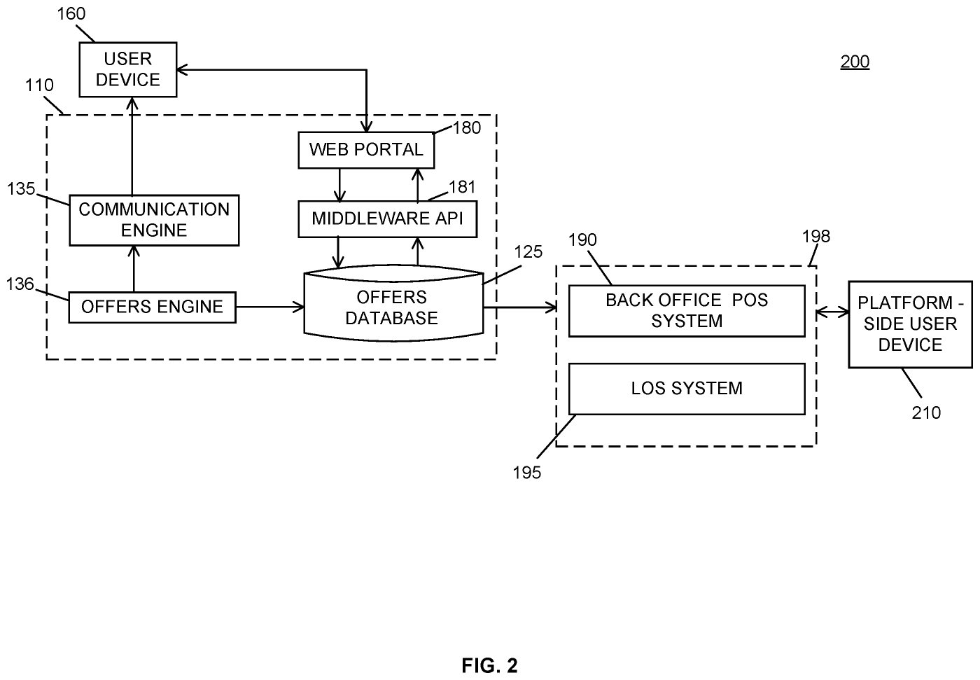

Turning now to FIG. 2, an exemplary system diagram 200 is shown. This diagram 200 highlights portions of the data intelligence platform 110 discussed above in connection with FIG. 1, and will be used to illustrate additional operations and functions thereof. Despite showing only some of its components, it should be understood that the data intelligence platform 110 depicted in FIG. 2 may include any of the components described herein and/or it may be configured to perform any of the operations described herein.

Continuing with the foregoing example, once the data intelligence platform 110 generates a user-specific product offering, it may be communicated to the particular user's user device 160 (e.g., via communication engine 135) via any number of communication channels (e-mail, text, etc.), and submitted to an offers database 126 (e.g., via offers engine 136) for storage. In this example, the offers database 126 may include any number and type of product offerings, including home-equity product offerings.

In some embodiments, all of the data collection, modeling, etc. associated with identifying, pre-approving and communicating the user-specific product offering may occur ahead of time, i.e., without user initiation or request, and upstream of any downstream processing functions 198 associated with the particular user-specific product offering.

In some embodiments, the user may prompt or request that the data intelligence platform 110 generate and present user-specific product offering(s) for which the user is pre-approved on-demand. In response, the data intelligence platform 110 may prompt the user for additional information or, if the data intelligence platform 110 already has sufficient data and information, automatically generate the user's user-specific product offering(s) with no further input from the user.

In some embodiments, the data intelligence platform 110 may periodically or continually identify and pre-approve the particular user (or any other user) for any number of user-specific product offerings. However, rather than automatically communicating the user-specific product offerings to the particular user, the data intelligence platform 110 may be configured to hold (and update) the user-specific offerings, and only communicate one or more of the user-specific product offerings responsive to a request from the particular user. In this manner, since the user-specific product offering(s) are determined ahead of time (e.g., prior to being requested or demanded), they may be provided to the particular user in real-time.

Upon receiving the pre-approved user-specific product offering, if the particular user wishes to accept, the particular user may access the data intelligence platform 110 via an interactive GUI displayed on the user device 160 that includes access to web offer portal 180 (e.g., by entering user credentials and identification information for the pre-approved user-specific product offering). In order to initiate the one or more downstream processing functions 198 (e.g., offer acceptance, under-writing, etc.), minimal additional data may be entered by the particular user (e.g., affirmation of best contact information, data required by regulations (e.g., home mortgage disclosure act or HDMA), customer consents, and the like) via the user device 160 through the web portal 180.

In some embodiments, the particular user may only be required to provide a formal consent/acceptance to the pre-approved user-specific product offering because the data intelligence platform 110 has already obtained, sourced, modeled and/or determined all other needed data and information pre-emptively (e.g., on a front end of the entire process and upstream of the other various downstream systems required for origination of the pre-approved user-specific product offering). In this manner, the user interaction with the data intelligence platform 110 may be minimized (e.g., reduced by as much as 80% or more), the platform's operating efficiency is improved (e.g., by automatically initiating processing functions upstream and ahead of any user request or initiation), and reducing latency (e.g., by eliminating and/or reducing downstream processing requirements).

Once the particular user is granted access to the data intelligence platform 110 (e.g., via the web portal 180), the data intelligence platform 110 may utilize middleware APIs 181 to correlate the particular user with the user's pre-approved user-specific product offering stored in the offers database 125. Once correlated, additional downstream processing functions provided, for example, by a combination of a back office point-of-sale (POS) systems 190 and/or a loan-origination system (LOS) 195, may be initiated using a combination of the data and information provided by the data intelligence platform 110 (ahead of time) and the additional data and information provided by the particular user upon accessing the web portal 180. One or more platform-side user(s) 210 may also access the data intelligence platform 110 and/or any of the downstream processing systems 198 to ensure completion of the downstream processing functions (e.g., under-writing).

In some embodiments, the same data and information that is provided by the data intelligence platform 110 to identify, build, pre-approve and communicate the user-specific product offering may be carried through to the application submission process and into downstream operations and processing (e.g., under-writing). This unique ability to integrate disparate types of data from various sources with systems across an entire end-to-end experience has proved historically to be a barrier for existing systems in this art. The Applicant has developed and now delivers a unique, distinctive solution to these (and other) challenges. As discussed above, this solution includes integrating the data intelligence platform 110 capability as an append to the very front-end of system operations, ahead of all subsequent downstream systems 198.

Integrated inputs obtained from and/or generated by the data intelligence platform 110 may be utilized, by the data intelligence platform 110, to build and create electronic documents (income statement, appraisal, title, lien report) needed for downstream processing of accepted user-specific product offerings. This may include populating saved document templates with data and information collected and/or generated by the data intelligence platform 110. Such electronic documents may be uniquely designed to plug into the downstream systems 190, 195, making them available for operations, under-writing, documentation compliance, etc., as required for the particular product. The automated creation and/or submission of electronic documents may effectively replace existing methodologies of obtaining paper or other documents directly from users and/or integrating with third party systems to obtain them. As will be appreciated, the data intelligence platform 110 eliminates burden, time, cost, paper from the process, while at the same time improving the overall efficiency of the system itself. Additionally, this allows for customized inputs to operational strategies that optimize downstream processing functions (e.g., under-writing). The data intelligence platform 110 also includes unique functionality for satisfying and/or complying with any number of policy or regulatory requirements, as discussed above.

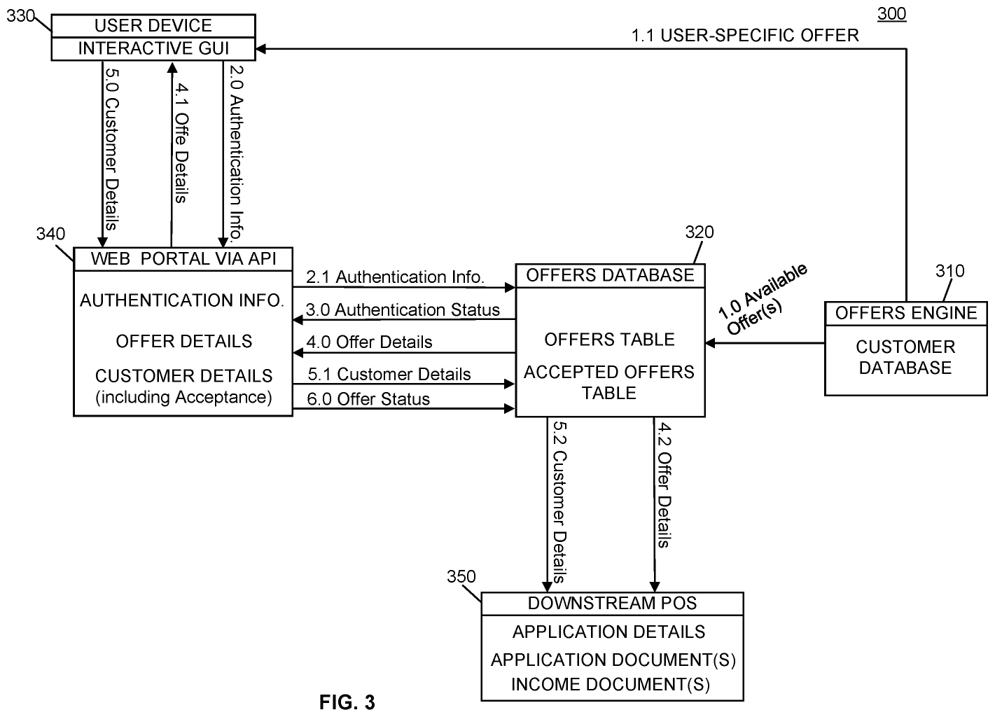

Turning now to FIG. 3, an exemplary flow diagram 300 is shown. This exemplary flow diagram 300 illustrates the flow of certain data and information (1.0)-(6.0) resulting from certain operations of a data intelligence platform (and related systems) according to the present disclosure, as well as from user interactions therewith. The components illustrated in FIG. 3, as well as their respective features and operations, are not intended to be exhaustive or exclusive, but are instead intended demonstrate certain aspects of a system according to the present disclosure. In addition, the type of data and information and the sequence in which it flows is not limited to the types and flow sequence illustrated in FIG. 3. To the contrary, more or fewer types of data and information may flow to and from more or fewer components in alternative sequences.

As described above, an offers engine 310 may generate any number of user-specific product offerings for any number of users. The user-specific product offerings (designated as “Available Offer(s)”) may then be sent to an offers database 320 for storage (1.0), for example, in one or more storage tables. Offer-specific details and information associated with each of the Available Offer(s), such as details of each user to which each offer pertains, terms and conditions of each offer, etc., may accompany the Available Offer(s) for storage in the offers database 320. In some embodiments, the Available Offer(s) (and associated data and information) may be sent to the offers database 320 periodically, as part of a flat-file, individually as created, or according to any other frequency and quantity.

In addition to sending Available Offer(s) to the offers database 320 for storage (1.0), the offers engine 310 may facilitate transmission (e.g., via a communication engine, now shown in FIG. 3) of a user-specific product offering from among the Available Offer(s) to a user device 330 associated with a particular user (1.1). Information from a customer database may be utilized to identify the particular user, the particular user's preferred communication channel, preferences of the particular user, and the like.

At the user device 330, the particular user may access and view the user-specific product offering via an interactive GUI of the user device 330. The interactive GUI may provide access to a web portal 340 of the data intelligence platform via an API. In order to access the user-specific product offering, the particular user may submit authentication information to the web portal 340 (2.0). The authentication information may include user-identifying information (e.g., partial social security number) and information that identifies the user-specific product offering (e.g., an offer-specific code).

The web portal 340 may then send the authentication information provided by the particular user to the offers database 320, to correlate the particular user with the user's user-specific product offering (2.1).

At the offers database 320, the particular user's user-specific product offering is identified and authenticated, and the status of the user-specific product offering is updated (e.g., in the offers table) and returned to the web portal 340 (3.0).

If the user-specific offer is located and remains current (e.g., the offer has not yet expired), the offers database 320 also returns offer details to the web portal 340 (4.0). The offer details may include, for example, offer terms, conditions, limits, additional acceptance requirements, assumptions used to generate user-specific product offering, etc.

The web portal 340 may then provide the offer detail information (“Offer Details”) to the user device 330 for review and consideration by the particular user (4.1).

In some embodiments, the Offer Details may also be transmitted to a downstream point-of-sale (POS) system 350 for pre-processing, which may include populating one or more formal application documents associated with the user-specific product offering before the user-specific offer is accepted (4.2). In some embodiments, the Offer Details may be transmitted to the downstream POS 350 system after the user-specific offer has been accepted (4.2).

At the user device 330, the particular user may access and view the Offer Details provided by the web portal 340. The particular user may initiate acceptance of the user-specific product offering by submitting an indication of acceptance, together with other requested user-specific information (collectively, “Customer Details”) to the web portal 340 (5.0). The indication of acceptance may include, for example, clicking a link or icon, entering text, etc.; and the other requested user-specific information may include, for example, updated income information, confirmation of assumptions used to generate the user-specific product offering, etc.

The web portal 340 may then send the Customer Details to the offers database 320 for storage and/or for later use in downstream processing (5.1).

In some embodiments, the offers database 320 may send the Customer Details to the downstream POS system 350 (5.2). The downstream POS system 350 may utilize the Customer Details, together with the Offer Details (4.2) to update or generate one or more formal application documents, income documents, or other application details associated with the user-specific product offering.

In some embodiments, the application documents, income documents and/or other documents may be generated by the data intelligence platform of the present disclosure, ahead of time, using data and information it has generated, captured, received and/or otherwise obtained, as discussed above. Once these formal documents are generated, further downstream processes may be initiated (e.g., under-writing, etc.).

The web portal 340 may also update the status of the user-specific product offering in the offers database 320, for example, by updating an accepted offers table.

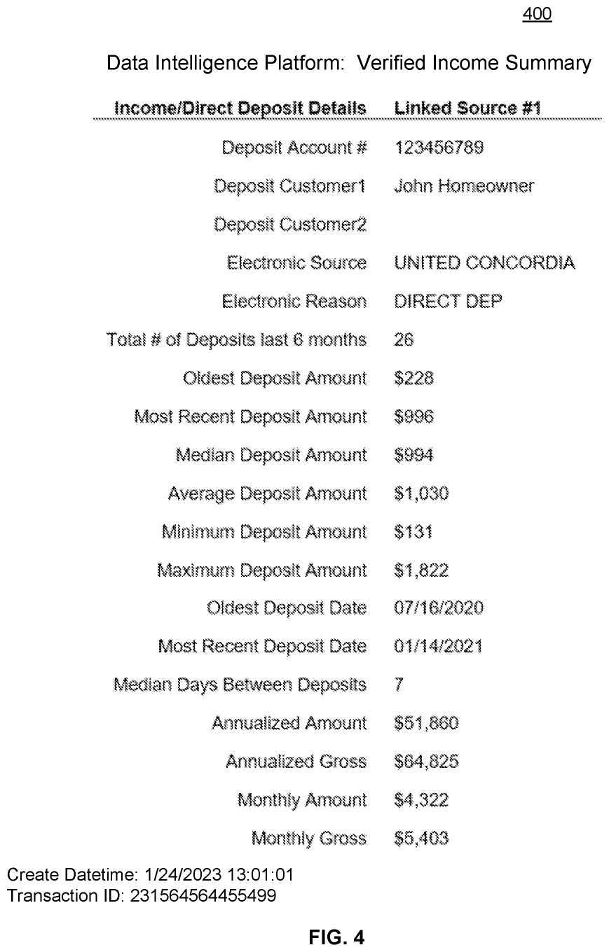

Turning now to FIG. 4, exemplary electronic document 400 that has been automatically (and intelligently) generated, in real-time, by a data intelligence platform (e.g., via a communication engine) according to this disclosure is shown. As noted above, documents such as this may be utilized by downstream processing systems for processing accepted user-specific product offerings, for example.

In order to create this electronic document 400, the data intelligence platform compiled a subset of the data and information that is has generated, captured, stored and/or modeled (discussed above). It has also curated and translated that data and information into a fit-for-purpose format, and then generated the electronic document 400 that complies with policies, rules, operational and/or regulatory requirements, and the like. In this example, the electronic document 400 shown represents a verified income summary statement that is indicative of a user's holistic wealth profile, while also complying with rules, policy, operational and/or regulatory document requirements, and the like. Notably, this exemplary document 400 represents only one type of document that may be generated by the data intelligence platform. Indeed, any type and/or quantity of electronic documents (e.g., reports, notices, etc.) may be generated by the data intelligence platform, automatically and in real-time, and in compliance with any required policy, operational and/or regulatory requirements, as needed.

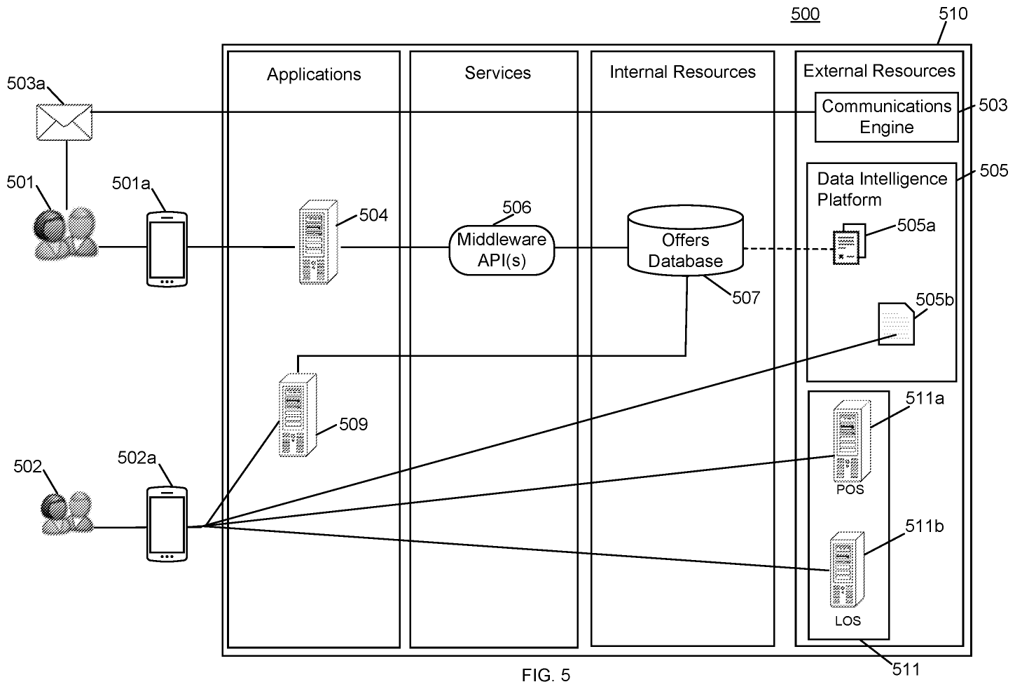

Turning now to FIG. 5, another exemplary system flow diagram 500 is shown. This exemplary diagram 500 shows the interaction between multiple users (e.g., pre-approved customer 501 and system-side colleague(s) 502) and a system 510 according to the present disclosure. As shown, the system 510 includes a data intelligence platform 505 that obtains, sources, models and/or generates user-specific product offerings 505a, as described herein. In this example, at least one pre-approved product offering among the user-specific product offerings 505a includes a home equity lending product having a particular set of characteristics (line or credit limit, interest rate, etc.) for which the pre-approved customer 501 is determined to qualify. The pre-approved product offering, together with general information associated with the pre-approved product offering (e.g., offer identification code, etc.), may be communicated to the pre-approved customer 501 via an email communication 503a generated, for example, by a communications engine 503. As explained above, other communication channels may also be used to communicate user-specific product offerings.

The pre-approved customer 501 may then access and view the pre-approved product offering by accessing the system's 510 application portal 504 via an internet browser of a user device 501a. In some embodiments, the system's 510 application portal 504 may be accessed via a software application downloaded onto the user device 501a. In some embodiments, the pre-approved customer 501 may proactively solicit pre-approved product offerings, by accessing the system's 510 application portal 504 and requesting the same.

Upon accessing the application portal 504, the pre-approved customer 501 may provide authentication details (e.g., that authenticates the pre-approved customer 501), information that identifies the pre-approved product offering (e.g., an offer identification code) and/or other information to the application portal 504. This information may then be used to locate, via one or more middleware application program interface(s) (API(s)) 506, the pre-approved product offering in an offers database 507, update its status, and return the same to the application portal 504 for access by the pre-approved customer 501. If the status is current (valid), additional details of the pre-approved product offering may also be returned to the application portal 504 for access by the pre-approved customer 501. In order to accept the pre-approved product offering, the pre-approved customer 501 may submit offer acceptance indicia, together with additional customer information, to the application portal 504. Upon submitting this additional information, the status of the pre-approved product offering may be updated (e.g., to accepted), and the additional information may be linked to the pre-approved product offering, in the offers database 507.

The accepted pre-approved product offering, together with the additional customer information, as well as one or more other accepted product offerings, may be provided (e.g., as a report or file) to a system-side portal 509 for access by the system-side colleague(s) 502 via respective user device(s) 502a. In addition, one or more electronic documents 505b generated by the data intelligence platform 505 may also be provided or made accessible to the system-side colleague(s) 502 via the respective system-side user device(s) 502a. As discussed above, the one or more electronic documents 505b may include, for example, a verified income summary (e.g., see FIG. 4), an appraisal and/or title document pertaining to a collateral asset, pre-populated application documents, and/or other documents pertaining to the pre-approved customer 501 and/or to collateral asset(s) of the pre-approved customer 501.

Upon receiving and/or accessing the accepted pre-approved product offering, any associated electronic document(s) 505b and/or any other data and information associated with the pre-approved customer 501, the system-side colleague(s) 502 may initiate, via the respective system-side user device(s) 502a, one or more downstream processes. This may include, for example, accessing and submitting the pre-approved product offering, any associated electronic document(s) 505b, etc. to one or more downstream processing systems 511, such as a point-of-sale (POS) system 511a and/or a loan origination system (LOS) 511b. In some embodiments, the downstream processes may include, for example, a formal application process, an under-writing process, and any other process associated with the pre-approved product offering.

In some embodiments, the system 510 may operate without intervention or involvement of any system-side colleague(s) 502. In such embodiments, the data intelligence platform 505 may automatically initiate one or more of the downstream processes by sending data and information, electronic documents, etc. associate with the pre-approved customer 501, the pre-approved product offering and/or the pre-approved customer's collateral asset(s) directly to the downstream processing systems 511. In some embodiments, the downstream processes (e.g., under-writing, application, etc.) may be initiated even before and/or in conjunction with the pre-approved product offering being transmitted to the pre-approved customer 501. In this manner, much of the downstream processing, modeling and/or decision making (e.g., product selection, customer pre-approval, under-writing processing, decision generation, etc.) may effectively be pre-executed/pre-determined (e.g., prior to the pre-approved customer 501 arriving at the system 510 to access, accept and/or apply for the pre-approved product offering), thereby improving overall system and process efficiencies. In addition, since the data intelligence platform 505 is continually learning and improving, system operating efficiency, accuracy, performance and other aspects of the system 510 will also be improved.

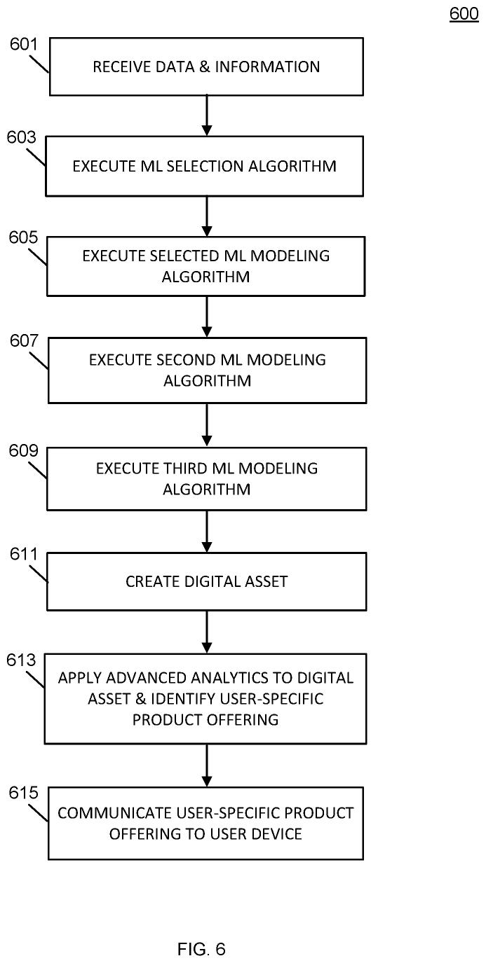

Turning now to FIG. 6, an exemplary method 600 for generating and communicating a user-specific product offering according to this disclosure is illustrated. In some embodiments, the method 600 may be executed by a data intelligence platform according described herein. The data intelligence platform may comprise one or more servers, one or more processors and a memory storing computer-readable instructions that, when executed by the one or more processors, cause the data intelligence platform to perform operations according to the exemplary method 600. Such operations may include, at step 601, receiving, from among one or more data sources, data and information associated with a user. In some embodiments, the one or more data sources may include one or more third-party systems, one or more storage devices, the data intelligence platform itself, etc.

The data and information may be received continually, periodically (e.g., according to a predetermined schedule) and/or on demand. Further, in addition to being received, the data and information may be extracted, generated, scraped (e.g., web scrape), monitored and captured, and/or otherwise obtained by any other means. In some embodiments, the data and information may include a combination of activity data associated with one or more user accounts, household data associated with the user, and collateral data associated with a collateral asset. The activity data may include data defining prior and/or existing user relationships with one or more entities associated with the data intelligence platform, the household data may include income and credit data, and/or the collateral data may include geographic data and competitive asset data.

At step 603, the data intelligence platform may execute a first ML modeling algorithm (e.g., an ML selection algorithm) that selects which, from among a plurality of ML modeling algorithms, to execute for determining a value profile associated with the collateral asset. In some embodiments, the plurality of ML modeling algorithms may include multiple ML algorithms configured to determine the value profile. Using collateral data as input, the ML selection algorithm is able to determine which, from among the multiple ML algorithms, is best suited (e.g., most accurate) for generating the value profile given particular parameters and details of the collateral data (e.g., geographic location).

Next, at step 605, the selected ML modeling algorithm may be executed, also using collateral data as input, to generate a collateral profile associated with the collateral asset. The collateral profile may include, for example, a predicted valuation (and valuation data) associated with the collateral asset.

At step 607, a second algorithm from among the plurality of ML modeling algorithms may then be executed, using the activity data as input, to generate an activity profile associated with the user. In some embodiments, the activity profile may include predicted user activity associated with the one or more accounts.

At step 609, a third algorithm from among the plurality of ML modeling algorithms may be executed, using the household data as input, to generate a household profile associated with the user. In some embodiments, the household profile may include a wealth and qualifications profile associated with the user.

Although the ML modeling algorithms described above in connection with steps 603-609 are shown being executed in a particular sequence, it should be understood that one or more of the ML modeling algorithms may be executed concurrently and/or in a different sequence without departing from the method 600.

Once the collateral profile (step 605), activity profile (step 607), and household profile (step 609) are generated, the method 600 may proceed to step 611, where the data intelligence platform may combine data from among the collateral profile, the activity profile and the household profile to create a digital asset (e.g., an array of data comprising various types of data and information from across various categories of data and information) that is in a format for processing by one or more downstream processing systems. This may include, for example, converting the digital asset (e.g., via a data converter) into a format that is compatible with the one or more downstream processing systems.

At step 613, advanced analytics may be applied to the digital asset, in connection with one or more rules and policies, to identify a pre-approved user-specific product offering. In some embodiments, applying advanced analytics may include executing one or more ML modeling algorithms, where the digital asset and data defining the rules and policies comprises the input into the one or more ML modeling algorithms. Since, as described above, the digital asset includes data indicative of the user's activity, the user's wealth and a value of the user's collateral asset, a holistic view of the user and the user's collateral is considered in identifying a user-specific product offering for which the user is likely to qualify. Further, inclusion of the rules and policies also ensures that the user-specific product offering complies with any relevant rules and policies.

Once the user-specific product offering is identified, the method 600 may proceed to step 615, which may include communicating the user-specific product offering to a user device associated with the user via one or more communication channels. The one or more communication channels may include, for example, text-message, email, or any other available communication channel.

In some embodiments, identifying the pre-approved user-specific product offering may include predicting a likelihood that the user will accept the user-specific product offering. This may include, for example, modeling attributes of the user's holistic profile and testing against profiles of other users having similar attributes. In such embodiments, the data intelligence platform may limit which user-specific product offerings to communicate to those having a predetermined likelihood of being accepted. In this manner, the operating efficiency of the data intelligence platform may be further improved.

As will be evident from the foregoing descriptions and embodiments, the data intelligence platform described herein is uniquely configured to deliver a fast and seamless customer experience by utilizing a comprehensive and consistent set of data and information, rules and policies, and strategies throughout all points of a user's end-to-end customer journey.

Indeed, as it pertains to the data intelligence platform, an exemplary customer journey may begin once the user receives a pre-approved user-specific product offering from the data intelligence platform. As will be evident, the data intelligence platform demonstrates its effectiveness and efficiency at the very first step in the customer journey by identifying and pre-approving the highly personalized user-specific product offering. Indeed, the user-specific product offering exhibits specific characteristics and/or parameters (e.g., commitments to timeframe, experience, loan parameters, etc.) that are tailored specifically for the specific user. As explained above, this ability is made possible, in part, because much of the processing, modeling and/or decision making is effectively pre-executed/pre-determined, and based on a comprehensive data asset that is particular to the user and that is collected, assembled and analyzed prior to the user arriving at the data intelligence platform to access, accept and/or apply for the user-specific product offering. The comprehensive data asset may include comprehensive personalized data that that crosses any number of key dimensions. A highly complex triangulation process (data engineering) that may include modeling multiple categories of data, combining aspects of the modeled data and applying advanced analytics thereto, is then implemented to generate a holistic and accurate view (profile) of the user and the user's collateral, as explained above. In some examples, the key dimensions may include (among others discussed herein) user type (borrower/customer), co-user type (e.g., co-borrower/affiliated customer), collateral asset type, credit worthiness, collateral valuation profile, rules and policies, business strategies, and others.

As detailed above, novel and unique features and functions of the data intelligence platform include, without limitation, its ability to (1) provide a comprehensive electronic pre-assembly of a highly complex multi-dimensional set of data/inputs; (2) utilize and implement proprietary modeling and processing methodologies for accurately bundling multiple individual (data) components into one cohesive electronic package (e.g., a digital asset) for further/downstream processing, evaluation and decision making; and (3) utilize proprietary analytics functions for decision making that is wholly compliant with any number of policy requirements (e.g., regulation, bank policy, and under-writing methodology and decisioning, etc.).

Once the user receives the pre-approved digital product offering, the user may accept the product offering by accessing an intelligent GUI that comprises an intuitive front-end that provides a modern user experience. In addition to confirming the user's acceptance, the user may submit user-authentication data, data identifying the user-specific product offering, as well as additional (sometimes minimal) data that may be utilized, in concert with the data used to generate the user-specific product offering, by the data intelligence platform to automatically straight-through-process downstream processing functions. These downstream processing functions may include, without limitation, confirming a status of the user-specific product offering, automated completion of a product application, automated application approval, automated under-writing, and automated closing and post-closing functions.

As will be appreciated, by proactively and automatically pre-executing many of the processing functions before the user even arrives at the data intelligence platform to view and/or accept the user-specific product offering, the data intelligence platform is able to minimize the user's interactions with the data intelligence platform (e.g., reduced by as much as 80% or more), improve system efficiency (e.g., by automatically initiating processing functions upstream and ahead of any user request or initiation), and reduce latency (e.g., by eliminating and/or reducing much of the downstream processing requirements). In addition, the data intelligence platform uniquely provides comprehensive coverage of all required data inputs needed to support compliance with rule policy requirements (e.g., regulatory), it utilizes a proprietary modeling methodology to combine disparate raw data inputs into persistent, reliable and accurate (up-to-date) profile(s) of a complex unit or entity (e.g., user (borrower), affiliated user (co-borrower), collateral (home property), etc.), and it provides improved downstream processing with quality data engineering specifications. As a result, the data intelligence platform of the present disclosure constitutes a substantial technological improvement in the art.

Turning now to FIGS. 7A-7K, exemplary interactive GUI screens 701-711 associated with a user experience (UX) according to the present disclosure are shown. The interactive GUI screens 701-711 may be displayed via a display element of a user device, for example. Collectively, the interactive GUI screens 701-711 depict a sampling of a user's journey for prompting or requesting, on-demand, that the data intelligence platform of this disclosure generate and present user-specific product offering(s) for which the user is pre-approved. It should be understood that the exemplary interactive GUI screens 701-711 shown on FIGS. 7A-7K are illustrative and non-limiting. Indeed, this and other UX journeys may include alternative, more or fewer interactive GUI screens having different layouts, displays and/or requests for different information. The interactive GUI screens may be sequenced differently, provide different combinations of features and functions, etc., all without departing from the scope of the present disclosure. In some embodiments, the particular sequence and/or configuration of the interactive GUI screens may be specific to the particular user and/or the particular user-specific product offering.

Turning now to FIG. 7A, a first interactive GUI screen 701 in this example may be characterized as a welcome screen 701. This exemplary welcome screen 701 may be configured to display a welcome message 701a, together with alerts and notices 701b, one or more prompts 701c and other data and information. In this example, the welcome screen 701 also includes a communication feature 701d that enables the user to connect with one or more system-side colleagues. Although the communication feature 701d shown in this example is configured to initiate a voice call, other embodiments may include alternative and/or additional communication features, such as a chat bot, text messaging, video chat, and so on. If selected, the communication feature 701d may be configured to connect multiple users and enable them to share and display content while communicating, all via the same interactive GUI screen. In this example, the communication feature 701d may be persistent throughout all screens of a user's journey, or it may appear on fewer than all screens, according to the embodiment.

In order to initiate generation and/or display of a new user-specific product offering, the user may select the ‘Get Me Started’ prompt 701e. In other embodiments, other prompts, commands, icons, etc. may be utilized to initiate generation of an on-demand user-specific product offering. If the user wishes to access a user-specific product offering that has already been generated (e.g., during a prior UX journey or automatically by the data intelligence platform, see FIGS. 8A-8C below), the user may select the ‘I already have an Invitation Code’ prompt 701f, which may lead the user through a different series of UX screens for retrieving, reviewing and/or accepting the user-specific product offering. In other embodiments, other prompts, commands, icons, etc. may be utilized to retrieve an existing user-specific product offering.

Upon selecting the ‘Get Me Started’ (or similar) prompt 701e, a second interactive GUI screen 702 may be displayed, as shown in FIG. 7B. This second interactive GUI screen 702 may present the user with a message 702a and respective prompts 702b, 702c to enable the user to apply for user-specific product offerings as a sole applicant or with a co-applicant. As noted above, the data intelligence platform may recognize that the user may be associated with and/or linked to one or more other users, and this option may be available in response to that recognition. In some embodiments, the option to include one or more co-applicants may be made available to all users. This screen 702 also includes navigation prompts (e.g., ‘Next’ 702e and ‘Back’ 702f) for navigating to a next or prior screen, respectively.

Upon making a selection to proceed as a sole applicant (e.g., by selecting prompt 702b) or a co-applicant (e.g., by selecting prompt 702c), and submitting that selection (e.g., by selecting the ‘Next’ prompt 702e), one or more inquiry screens 703-705 as shown in FIGS. 7C-7E, respectively, may be displayed. These inquiry screens 703-705 may be configured to prompt the user for additional information that may be utilized to identify and/or generate one or more user-specific product offerings. In some example, the user may provide the additional information by entering text, uploading documents, selecting from a drop down menu, clicking selection buttons, and the like. In this example, the inquiry screens 703-705 may include a screen 703 (shown in FIG. 7C) for obtaining information about the primary applicant (e.g., the user) 703a, a screen 704 (shown in FIG. 7D) for obtaining information about the user's collateral asset (e.g., home) 704a, and a screen 705 (shown in FIG. 7E) for obtaining information about the user's wealth and identity 705a. Each of these screens 703-705 may also include navigation prompts (e.g., 703b-c, 704b-c, 705b-c) for navigating to a next or prior screen, respectively.

In some embodiments and/or UX journeys, alternative and/or additional inquiry screens may be displayed including, for example, when more than user is applying as a co-applicant with one or more additional users. In such embodiments, alternative and/or additional screens (not shown) may be displayed to obtain information about the co-applicant(s).

In some embodiments, fewer or no inquiry screens may be needed if, for example, the data intelligence platform already has some or all needed data and information. In such embodiments, the data intelligence platform may proceed to auto-populate data fields with data and information it has, and prompt the user to provide any data and information still needed. If the data intelligence platform has all needed data and information, the user may proceed directly to a confirmation screen (e.g., screen 706 shown in FIG. 7F, discussed below) to confirm the accuracy of the data and information.

Upon completing the inquiry screens 703-705 (or portions thereof that have not been pre-populated), the user may advance to a confirmation screen 706, as shown in FIG. 7F. This confirmation screen 706 may include an instructional/advisory message 706a, a summary 706b of the information provided by the user (e.g., via the inquiry screens 703-705), by any co-applicant(s) and/or as identified/pre-populated by the data intelligence platform may be displayed. In this example, the confirmation screen 706 may also provide information as to next steps in the UX journey 706c, a consent option 706d (e.g., to consent to a ‘soft’ credit check), and a confirmation prompt (“Check my Offer”) 706e for confirming the accuracy and/or completeness of the information and for prompting the data intelligence platform to generate (or identify) and display one or more user-specific product offerings as described above. If any of the summary information 706b is incorrect or incomplete, the user may go back and revise the same by selecting the ‘Back’ navigation prompt 706f and/or by selecting the ‘Edit’ prompt 706g.

Once the ‘Check my Offer’ prompt 706e is selected, the data intelligence platform may proceed to identify and/or generate one or more user-specific product offerings as discussed herein. The user-specific product offering(s) may then be displayed in an offer screen 707, as shown in FIG. 7G, together with an introductory message that includes an overview of the user-specific product offering(s) 707a, one or more prompts (e.g., ‘Get This Offer!’) 707b for accepting and/or initiating an application process associated with the user-specific product offering, and information as to documents, action items, etc. 707c needed to complete the application process. In this example, the user-specific product offering comprises a home equity line of credit (HELOC) in an amount of $130,000 that may be repaid at a 9.00% variable annual percentage rate (APR). The time to close on the HELOC is estimated to be as little as one week, no home appraisal is needed, and only a limited amount of documents will be needed. In other embodiments, additional or alternative information relating to the user-specific product offering(s) may be displayed. For example, information such as details of the collateral asset(s) on which the user-specific product offering(s) are based (e.g., an address of a property on which the HELOC product is based), available discounts, options to request an alternative user-specific product offering (e.g., a larger/smaller HELOC), etc.

Selecting the acceptance/application prompt 707b may then cause the data intelligence platform to initiate an application process, which may include generating and/or displaying one or more additional inquiry screens. In some embodiments, the additional inquiry screens may prompt the user to provide additional information about the user (and/or any co-applicants), the user's collateral asset(s), the user's income, and/or any other type of data and information that may be utilized to apply for the user-specific product offering. For example, FIG. 7H shows an additional inquiry screen 708 that may be used to collect information pertaining to how the user will utilize the HELOC product 708a, and FIG. 7I shows another additional inquiry screen 709 that enables the user to elect how the HELOC will be repaid (e.g., interest-only vs principal and interest) 709a. Each of these additional inquiry screens 708, 709 may other information, inquiries, features, etc. For example, screens 708 and 709 include a respective summary of the user-specific product offering 708b, 709b, and respective navigation prompts 708c-d, 709c-d for navigating to a next or prior screen.

In some embodiments, alternative, more or fewer screens may be utilized to gather and provide different, more or less information, features and/or functions. In some embodiments, fewer or no additional inquiry screens may be needed if, for example, the data intelligence platform already has the needed data and information to initiate the application process.

Once all of the additional inquiry screens (e.g., screens 708-709), if any, have been completed (or if no additional inquiry screens are needed), one or more screens for confirming an accuracy of all gathered information (e.g., similar to screen 706) may be displayed. In addition, as shown in FIG. 7J, one or more screens 710 for consenting to certain terms and conditions 710b and for formally submitting an application may be displayed to the user. In this example, interactive GUI screen 710 displays user requirements relating to credit report authorization, reviewing documents electronically, setting up automated payments, etc. Also displayed on this interactive GUI screen 710 are a summary of the user-specific product offering 710a, terms of use 710c (which includes a link for reviewing certain disclosures), and a prompt 710d that enables the user to consent to all terms listed on this screen 710. In other embodiments alternative terms and conditions, and prompts for access, reviewing and accepting the same may be displayed.

By providing all requested information, confirming its accuracy and consenting to all terms and conditions, the user may then formally submit an application for the user-specific product offering. To that end, interactive GUI screen 710 may further include a submission prompt 710e (labeled ‘Submit Application’) that, once selected, formally submits the user's application for the user-specific product offering for further processing.

Submission and approval of the application may result in a final confirmation screen 711 being displayed, as shown in FIG. 7K. As shown, this exemplary final confirmation screen 711 confirms that the user has accepted and applied for the user-specific product offering 711a, as well as information as to “what happens next.” 711b. As to other interactive GUI screens described herein, this final confirmation screen 711 may include alternative, additional and/or less information and/or features that may be tailored to the particular user and/or user-specific product offering.

Turning now to FIGS. 8A-8C, exemplary interactive GUI screens 801-803 associated with an excerpt of user experience (UX) according to the present disclosure are shown. The interactive GUI screens 801-803 may be displayed via a display element of a user device, for example. Collectively, the interactive GUI screens 801-803 shown in FIGS. 8A-8C, respectively, depict a user's journey for accessing a user-specific product offering that was generated automatically by the data intelligence platform of the present disclosure, without a user request or prompting. Other embodiments may include alternative, more or fewer interactive GUI screens having different layouts, displays and/or requests for different information, be sequenced differently, provide different combinations of features and functions, etc., all without departing from the scope of the present disclosure.

As described above, the user-specific product offering may be identified and/or generated automatically by the data intelligence platform of this disclosure, without user input or prompting. The data intelligence platform may similarly pre-approve the user for the user-specific product offering and automatically communicate the user-specific product offering to the user via any number of delivery channels (e.g., text message, email, etc.). In order to access and review the user-specific product offering, the user may access a web offer portal of the data intelligence platform via an interactive GUI displayed on the user's device, for example.

Once access to the web offer portal is granted, the user may view a welcome interactive GUI screen 801, as shown in FIG. 8A. This welcome screen 801 may display a welcome message 801a, alerts and notices 801b, one or more prompts 801c and other data and information. In this example, the welcome screen 801 also includes a communication feature 801d that enables the user to connect with one or more system-side colleagues. As noted above, the communication feature 801d may be configured to initiate one or more of a voice call, a chat box, text messaging, video chat, and so on. If selected, the communication feature 801d may be configured to connect multiple users and enable them to share and display content while communicating, all via the same interactive GUI screen. The communication feature 801d may be persistent throughout all screens of a user's journey, or it may appear on fewer than all screens.

In order to access the user-specific product offering, the user may select the ‘I already have an Invitation Code’ prompt 801f, which may lead the user to a subsequent authentication screen 802, as shown in FIG. 8B. In other embodiments, other prompts, commands, icons, etc. may be utilized to retrieve an existing user-specific product offering. In order to initiate generation and/or display of an on-demand user-specific product offering, the user may select the ‘Get Me Started’ prompt 801e, as discussed above with respect to FIG. 7A.

Upon selecting the ‘I already have an Invitation Code’ (or similar) prompt 801f, an authentication interactive GUI screen 802, as shown in FIG. 8B, may be displayed. This authentication interactive GUI screen 802 may display an informational/instructional message 802a, as well as prompts 802c, 802d for entering authenticating user and/user-specific product offering information, and one or more navigation prompts (e.g., ‘Next’ 802e and ‘Back’ 8020 for navigating to a next or prior screen, respectively. In this example, the authentication prompts include an offer identity prompt 802c and a user identity prompt 802d. The offer identity prompt 802c may be configured to request and receive an offer code that may have been delivered to the user together with the user-specific product offering, and the user identity prompt 802d may be configured to request and receive identity information that is unique to the user. In this example, a portion of the user's social security number may satisfy the user identity prompt 802d, although in other embodiments, other user identifying information may be requested and utilized.

Entering and submitting the requested authentication information may prompt the data intelligence platform to perform certain operations that include confirming an accuracy of the entered information (e.g., do the user and offer code match?), and confirming that the user-specific product offering remains available (e.g., it has not expired). If the user and offer code are successfully authenticated, and the user-specific product offering remains available, the data intelligence platform may retrieve and display the user-specific product offering via an offer screen 803, as shown in FIG. 8C. If, however, the user and offer code are not authenticated and/or the user-specific product offering has expired, the user may be returned to interactive GUI screen 802 to attempt to re-enter the authentication information or to interactive GUI screen 801, where the user may prompt the data intelligence platform to identify and/or generate a new user-specific product offering on-demand.

As shown in FIG. 8C, the offer screen 803 may include an introductory message 803a that includes an overview of the user-specific product offering(s), one or more prompts (e.g., ‘Get This Offer!’) 803b for accepting and/or initiating an application process associated with the user-specific product offering, and information as to documents, action items, etc. 803c involved in completing the application process. In this example, the user-specific product offering comprises a home equity line of credit (HELOC) in an amount of $215,000 that may be repaid at a 6.50% variable annual percentage rate (APR). The time to close on the HELOC is estimated to be as little as one week, no home appraisal is needed, and only a limited amount of documents will be needed. In other embodiments, additional or alternative information relating to the user-specific product offering(s) may be displayed. For example, information such as details of the collateral asset(s) on which the user-specific product offering(s) are based (e.g., an address of a property on which the HELOC product is based), available discounts, options to request an alternative user-specific product offering (e.g., a larger/smaller HELOC), etc.

Upon selecting the acceptance/application prompt 803b (e.g., ‘Get This Offer!’), the data intelligence platform may initiate an application process. As discussed above, the application process may involve navigating through another series of interactive GUI screens, such as those discussed above with reference to FIGS. 7H-7K, for example. Successful submission of an application associated with the user-specific product offering may culminate in a final confirmation screen being displayed. Such a final confirmation screen may confirm that the user has accepted and applied for the user-specific product offering, as well as provide information as to “what happens next.”

A computer-readable storage medium is also contemplated by the present disclosure. The computer-readable storage medium includes one or more sequences of computer-readable instructions that, when executed by one or more processors, cause a computer device, system and/or platform to perform any of the operations described herein, including those described as being performed by a data intelligence platform and/or its related components, devices and/or systems.

Systems and methods of the present disclosure may include and/or may be implemented by one or more specialized computers including specialized hardware and/or software components. For purposes of this disclosure, a specialized computer may be a programmable machine capable of performing arithmetic and/or logical operations and specially programmed to perform the functions described herein. In some embodiments, computers may comprise processors, memories, data storage devices, and/or other components. These components may be connected physically or through network or wireless links. Computers may also comprise software which may direct the operations of the aforementioned components. Computers may be referred to as servers, personal computers (PCs), mobile devices, and other terms for computing/communication devices. For purposes of this disclosure, those terms used herein are interchangeable, and any special purpose computer particularly configured for performing the described functions may be used.

Computers may be linked to one another via one or more networks. A network may be any plurality of completely or partially interconnected computers wherein some or all of the computers are able to communicate with one another. Connections between computers may be wired in some cases (e.g., via wired TCP connection or other wired connection) or may be wireless (e.g., via a WiFi network connection). Any connection through which at least two computers may exchange data can be the basis of a network. Furthermore, separate networks may be able to be interconnected such that one or more computers within one network may communicate with one or more computers in another network. In such a case, the plurality of separate networks may optionally be considered to be a single network.

The term “computer” shall refer to any electronic device or devices, including those having capabilities to be utilized in connection with an electronic information/transaction system, such as any device capable of receiving, transmitting, processing and/or using data and information. The computer may comprise a server, a processor, a microprocessor, a personal computer, such as a laptop, palm PC, desktop or workstation, a network server, a mainframe, an electronic wired or wireless device, such as for example, a telephone, a cellular telephone, a personal digital assistant, a smartphone, an interactive television, such as for example, a television adapted to be connected to the Internet or an electronic device adapted for use with a television, an electronic pager or any other computing and/or communication device.

The term “network” shall refer to any type of network or networks, including those capable of being utilized in connection with the systems and methods described herein, such as, for example, any public and/or private networks, including, for instance, the Internet, an intranet, or an extranet, any wired or wireless networks or combinations thereof.

The term “computer-readable storage medium” should be taken to include a single medium or multiple media that store one or more sets of instructions. The term “computer-readable storage medium” shall also be taken to include any medium that is capable of storing or encoding a set of instructions for execution by the machine and that causes the machine to perform any one or more of the methodologies of the present disclosure.

While the present disclosure has been discussed in terms of certain embodiments, it should be appreciated that the present disclosure is not so limited. The embodiments are explained herein by way of example, and there are numerous modifications, variations and other embodiments that may be employed that would still be within the scope of the present disclosure.

What is claimed is:

1. A system comprising:
a data intelligence platform comprising one or more servers, one or more processors and a memory storing computer-readable instructions that, when executed by the one or more processors, cause the data intelligence platform to:
receive, from among one or more data sources, data and information associated with a user, the data and information comprising activity data associated with one or more user accounts, household data associated with the user, and collateral data associated with a collateral as set;
execute a first machine learning (ML) modeling algorithm that selects which ML modeling algorithm, from among a plurality of ML modeling algorithms, to execute for determining a value profile associated with the collateral asset, said first ML modeling algorithm receiving the collateral data as input; [inventors: please provide more details on how model is selected (what criteria, what data is input?)]
execute the selected ML modeling algorithm to generate a collateral profile associated with the collateral asset;
execute a second ML modeling algorithm from among the plurality of ML modeling algorithms to generate an activity profile associated with the user, the second ML modeling algorithm receiving the activity data as input;
execute a third ML modeling algorithm from among the plurality of ML modeling algorithms to generate a household profile associated with the user, the third ML modeling algorithm receiving the household data as input;
combine data from among the collateral profile, the activity profile and the household profile to create a digital asset that is in a format for processing by one or more downstream processing systems;
apply advanced analytics to the digital asset, in connection with one or more rules and policies, to identify a user-specific product offering for which the user is pre-approved; and
communicate the user-specific product offering to a user device associated with the user via one or more communication channels.

2. The system of claim 1, wherein the one or more data sources comprises a combination of one or more third-party systems, one or more user devices, one or more storage devices, and one or more components of the data intelligence platform.

3. The system of claim 1, wherein at least a portion of the data and information is at least one of extracted and generated by the data intelligence platform, and wherein the data and information is received, extracted or generated at least one of continually, periodically and on-demand.

4. The system of claim 1, wherein the household data comprises income and credit data, the collateral data comprises geographic data and competitive asset data, and the activity data comprises data defining prior and existing user relationships with one or more entities associated with the system.

5. The system of claim 1, wherein the collateral profile comprises predicted valuation data of the collateral asset, the activity profile comprises predicted user activity associated with the one or more accounts, and the household profile comprises a wealth and qualifications profile associated with the user.

6. The system of claim 1, wherein the data intelligence platform is further configured to:
monitor at least one among the one or more data sources for changes to any of the data and information;
detect a change to the data and information; and
re-execute at least one among the plurality of ML modeling algorithms responsive to the detected change.

7. The system of claim 6, wherein the data intelligence platform is further configured to:
update at least one among the collateral profile, the activity profile and the household profile based on the re-execute;
update the digital asset to reflect updates to at least one among the collateral profile, the activity profile and the household profile;
re-apply advanced analytics to the updated digital asset, in connection with the one or more rules and policies, to identify at least one updated user-specific product offering for which the user is approved; and
communicate the updated user-specific product offering to the user device.

8. The system of claim 6, wherein the detected change to the data and information comprises an update to the one or more rules and policies, the data intelligence platform being further configured to:
re-apply the advanced analytics to the digital asset in connection with the update to the one or more rules and policies; and
identify a new user-specific product offering for which the user is pre-approved.

9. The system of claim 6, wherein the data intelligence platform is configured to perform said monitor at least one of continually, periodically and on-demand.

10. The system of claim 1, wherein the data intelligence platform is further configured to generate an interactive graphic user interface (GUI) for displaying the user-specific product offering on the user device.

11. The system of claim 10, wherein the data intelligence platform is further configured to at least one of:
transmit the interactive GUI to the user device for rendering thereon; and
render the interactive GUI and transmit the rendered interactive GUI to the user device for display thereon.

12. The system of claim 10, wherein the data intelligence platform is further configured to dynamically update the interactive GUI to display one or more updates as they occur.

13. The system of claim 12, wherein the one or more updates comprise at least one of a change to the user-specific product offering, a change resulting from execution or re-execution of one or more among the plurality of ML modeling algorithms, a change resulting from re-application of the advanced analytics, and a change to the data and information.

14. The system of claim 1, wherein applying advanced analytics to the digital asset comprises executing one or more ML modeling algorithms using the digital asset and the one or more rules and policies as input.

15. The system of claim 1, wherein the data intelligence platform further comprises a storage device for storing the user-specific product offering together with multiple other user-specific product offerings associated with a plurality of other users.

16. The system of claim 15, wherein the data intelligence platform is further configured to send a combination of the user-specific product offering and the multiple other user-specific product offerings to the storage device at least one of periodically in a batch file and individually as each user-specific product offering is generated.

17. The system of claim 15, wherein the data intelligence platform further comprises a web portal for interacting with the user device.

18. The system of claim 17, wherein the data intelligence platform is further configured to:
receive, by the web portal via an application program interface (API),
authentication information from the user device, the authentication information comprising user-identifying information and information that identifies the user-specific product offering;
authenticate the user and identify the user-specific product offering based on the authentication information;
update a status of the user-specific product offering in the storage device; and
return offer details associated with the user-specific product offering to the web portal for access by the user device.

19. The system of claim 18, wherein the data intelligence platform is further configured to:
receive, by the web portal via the API, customer details from the user device, the customer details including an indication of acceptance of the user-specific product offering and user-specific information associated with the user;
store the customer details in the storage device; and
update the status of the user-specific product offering to reflect the indication of acceptance.

20. The system of claim 19, wherein the data intelligence platform is further configured to:
transmit the offer details associated with the user-specific product offering to one or more downstream processing systems;
transmit the customer details to the one or more downstream processing systems; and
initiate one or more downstream processes based on the offer details and the customer details.

21. The system of claim 20, wherein the data intelligence platform is further configured to initiate the one or more downstream processes before receiving the indication of acceptance.

22. The system of claim 20, wherein the one or more downstream processes comprises one or more of an application process, an under-writing process, a closing process and a post-closing process.

23. The system of claim 20, wherein the data intelligence platform is further configured to automatically generate one or more electronic documents or use in the one or more downstream processes.

24. The system of claim 20, wherein the downstream processing systems comprise one or more of a point-of-sale (POS) system and a loan-origination system (LOS).
